(19) United States
(12) Patent Application Publication
(10) Pub. No.: US 2005/0177624 A1
(43) Pub. Date: Aug. 11, 2005

(54) Distributed System and Methodology for Delivery of Media Content to Clients having Peer-to-peer Connectivity

(75) Inventors: Jack Oswald, San Francisco, CA (US); David M. Williams, San Francisco, CA (US)

Correspondence Address: JOHN A. SMART, 708 BLOSSOM HILL RD., #201, LOS GATOS, CA, 95032, US

(73) Assignee: ALIO, INC., San Francisco, CA (US)

(21) Appl. No.: 10/709,392

(22) Filed: Apr. 30, 2004

Related U.S. Application Data
(60) Provisional application No. 60/521,052, filed on Feb. 11, 2004.

(51) Int. Cl. G06F 15/16

(52) U.S. Cl. 709/219

(57) ABSTRACT

A distributed system and methodology for delivery of media content to clients having peer-to-peer connectivity is described. In one embodiment, for example, a method of the present invention is described for distributing media comprises: receiving at a server a request from a first client for a particular media item, the first client having broadband connectivity to other clients; at the server, determining a second client who has an encrypted copy of the desired media item; transferring the encrypted copy of the desired media item from the second client to the first client; after the encrypted copy has been transferred to the first client, indicating at the first client that the desired media item is now available; and in response to receiving payment authorization from the first client, decrypting the desired media item for use at the first client.

### CROSS REFERENCE TO RELATED APPLICATIONS

The present application is related to and claims the benefit of priority of the following commonly-owned, presently-pending provisional application(s): application Ser. No. 60/521,052 (Docket No. ALIO/0001.00), filed Feb. 11, 2004, entitled “Distributed System and Methodology for Delivery of Media Content”, of which the present application is a non-provisional application thereof. The present application is also related to the following commonly-owned, presently-pending application(s): application Ser. No. ______ (Docket No. ALIO/0001.01), filed ______, entitled “Distributed System and Methodology for Delivery of Media Content”; application Ser. No. ______ (Docket No. ALIO/0001.03), filed ______, entitled “System and Methodology for Distributed Delivery of Online Content in Response to Client Selections from an Online Catalog”. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 106 KB, created Feb. 11, 2004 6:37 PM; Object ID: File No. 1; Object Contents: Source Code.

### BACKGROUND OF INVENTION

1. Field of the Invention

The present invention relates generally to a system providing methods for distribution and playback of media content, with particular emphasis on techniques that allow distributed distribution of media content via a network such as the Internet.

2. Description of the Background Art

Today, video content is being distributed to a large number of consumers. In the past, video content has mainly been distributed via broadcast method, namely terrestrial broadcast from an antenna, a satellite, a cable, or the like. In this environment, consumers have long desired access to a much broader variety of media than can possibly be delivered using the broadcast method of distribution. A particular advantage of the broadcast method is that a particular media item, such as a movie, is transmitted once and everyone receives it. This approach works well in an environment with a small number of channels, such as in a market served by the four major television networks. However, as people have started to desire more variety in the media that they view, the foregoing advantage turns into a disadvantage because everyone gets exactly the same thing.

Over time, more channels have gradually become available to consumers. In part, this is due to increasingly greater communication capacity devoted to transmitting media. Another factor is the improvement in the ability to compress media, thus allowing increasing amounts of media to be delivered over existing pathways.

Several technologies have also emerged in order to meet the demand for a broader variety of media. One example, using cable broadcast, is “video on demand” (VOD). Here, the consumer is able to request a particular movie or video item, whereupon the cable company is able to provide that item directly to the consumer. In contrast, “pay per view” (PPV) is a more conventional method whereby a cable operator provides some number of PPV channels (from the available limited number of channels), each PPV channel being devoted to showing a schedule of certain movies that the consumer may subscribe to (or not). The movies shown on the PPV channels technically are available to all cable users; however, the movies are encoded such that only the (few) users who are subscribing at that moment of broadcast may unlock the content (e.g., via a key sent to the user's set-top box). Given the finite number of channels available for broadcast in that environment, PPV and (especially) VOD are not a particularly good use of available broadcast bandwidth.

More recently, the Internet has been used to try to meet this broader media demand. The Internet is an attractive channel since it is widely available in many homes, and at ever increasing bandwidth. Currently, delivery of media content through the Internet has primarily used a “streaming” technique to a PC. “Streaming” is a technique in which the consumer goes to an online video library, selects an item that he or she wants, and then a server (i.e., the computer that the consumer is communicating with on the Internet) will proceed to provide that stream of information to the consumer (e.g., using Apple QuickTime, Microsoft Windows Media Player, RealOne media player, or the like).

The Internet can also provide another way of delivering content. As before, the consumer selects a particular item of interest (e.g., from an online catalog or library) for viewing sometime in the future. However, the server does not immediately stream that item to the consumer but instead transfers it on a less urgent basis. The item is eventually downloaded to a playback device, such as a set-top box with hard disk storage, whereupon the user may then proceed to view the content.

Another distribution method available on the Internet is “peer-to-peer” (P2P) distribution. In using a P2P network, such as Kaaza, users can obtain information and content from each other, without the use of a server. A peer-to-peer network is typically a cooperative environment that allows each user (i.e., node) to have a view into (i.e., access to content from) all other users (nodes) that are currently available on the network. Therefore, the actual content available to a given user on the network is constantly shifting, as nodes are constantly shifting in and out of the network. The user also controls which specific file he or she is selecting from other specific nodes.

Each of the foregoing distribution methods has its own set of limitations. With the cable distribution method, there is a very limited supply (channel bandwidth) to begin with, so cable operators are forced to have fewer and fewer consumers served by an individual channel in order to increase variety. It is very expensive for cable operators to add the equipment to supply an increasing number of increasingly smaller market segments. VOD is also inefficient and expensive because the service provider needs to use one unique channel, from the limited supply, per user. They must also purchase and install sufficient server capacity to match peak user demand which is only used for short periods per week. The problem with Internet streaming is that presently there is still relatively low bandwidth available, and thus picture quality tends to be poor. For example, a 1 Mps download capability (e.g., with DSL) limits a consumer's real-time ability to 1 Mps (at best), which is insufficient to sustain high-quality images. As a result, the streaming approach generally provides a much poorer viewing experience compared to viewing a video from a digital video disk.

Internet streaming has an even more pronounced limitation. No matter how users (clients) are able to receive data, if a given user has a 1 Mps download capability, that means that there is a corresponding 1 Mps stream that must be sent from the server. As additional users are added, such an approach scales poorly. For example, the system may have sufficient capacity to handle 100 simultaneous users initially, thereby serving one hundred streams of 1 Mps each. Quickly however, as soon as that system encounters any sort of commercial success, the system is unable to keep up with the infrastructure required to serve increased demand. The problem is exacerbated by the cyclical nature of consumer demand, which peaks at certain times. In order to have a certain quality of service, a provider is required to build out infrastructure that is capable of handling peak loads. Note, however, that during off-peak times that extra capacity is underutilized (in much the same manner as described for the cable VOD operator above). Even if the foregoing limitations were solved, today Internet streaming still suffers from compromised picture quality due to the relatively low bandwidth that is available.

The problem with peer-to-peer solutions is that they present a chaotic source of data. Peer-to-peer environments are very hard to manage and even harder to make secure. Peers that one expects to communicate with may or may not be available. One is forced to rely on the goodwill of others which, in a general computing environment, does not provide any sort of reliable access to quality media assets. As a result, users cannot expect access to quality media items on a consistent basis, nor can users even be assured that they are not obtaining an item infected with a computer virus or worm. As an additional problem, current peer-to-peer solutions provide little protection for a content provider's underlying copyright rights, and in fact have served as a mechanism for rampant piracy. Not surprisingly, content providers to date have been very reluctant to embrace peer-to-peer technology.

Today, there is a well-developed environment through which video and other digital media may be delivered. A large number of consumers in the United States and around the world have broadband access to the Internet. “Broadband” generally refers to download/upload capability that is improved over conventional “dial-up” (e.g., 56 K modem) access. Examples include cable modem, DSL, T1, T3, or the like. With cable modem broadband access, for example, consumers can typically expect download capability of approximately 1 Mps or greater and upload capability of approximately 256 Kps. This represents an existing resource that is available for distribution of media.

In addition to existing broadband connectivity, consumers have access to increasingly more powerful set-top boxes (STBs). A set-top box is basically a computer device (i.e., microprocessor, memory, and storage) that is usually connected directly to the television. The name “set-top” refers to the fact that these devices are often placed on top of a television set. Set-top boxes have typically been used in the past as decoders. Here, a set-top box receives a cable feed or satellite dish feed as input. After converting/decoding the incoming signal, the set-top box provides an output signal capable of being displayed on television (e.g., normal NTSC video).

Recently, a number of new features have been added to the design of set-top boxes. A current trend, for example, is to add digital television recording (DTR) capability. Examples include TiVo and Replay TV. This feature takes advantage of the fact that incoming information can be digitized, or is already digitized, and therefore can easily be stored on a set-top box hard disk and then replayed in the future. In response to consumer demand for DTR, set-top boxes with hard disk storage capability are becoming very prevalent.

Network connectivity is another feature recently added to set-top boxes. This allows a set-top box to have access to all of the resources available on the Internet. Although an Internet-enabled set-top box could be connected directly to a DSL or cable modem, the device is more likely to be connected to a home network. Increasingly, users are setting up an in-home LAN (local area network) to allow multiple devices within the home to communicate with each other (e.g., for printer and file sharing) as well as to provide those devices with uniform access to the Internet. Internet connectivity is typically achieved by connecting the home network to a bridge/switch that has Internet connectivity (e.g., from a connected DSL or cable modem). Common examples of home networks include HomePNA (phone line based), HomePlug (powerline based), and WiFi (wireless based).

What is needed is a solution for delivery of media content into the well-developed environment described above which provides users with a wide variety of selections and delivers high-quality content. The solution should efficiently deliver media content while minimizing the total amount of network bandwidth and server infrastructure investment that the content provider needs in order to deliver media content within a reasonable period of time. In addition, the solution should incorporate digital rights management technology to secure the media content against unauthorized use. The present invention provides a solution for these and other needs.

### SUMMARY OF INVENTION

A distributed system and methodology for delivery of media content to clients having peer-to-peer connectivity is described. In one embodiment, for example, a method of the present invention is described for distributing media content to clients having peer-to-peer connectivity, the method comprises steps of: hosting an online catalog having a selection of media items available from a central repository, wherein at least some of the media items have already been previously transferred from the central repository to some of the clients; responsive to the online catalog, receiving from each client a prioritized list of media items desired to be received for use; based on the prioritized lists received from the clients and based on where various media items reside, determining a schedule for transferring media items; and transferring the media items pursuant to the schedule, including transferring at least some of the items between clients using peer-to-peer connectivity.

In another embodiment, for example, a system of the present invention is described for distributing media content to clients having peer-to-peer connectivity, the system comprises: an online catalog having a selection of media items available from a central repository, wherein at least some of the media items have already been previously transferred from the central repository to some of the clients; a server for receiving from each client a prioritized list of media items desired to be received for playback, and for determining a schedule for transferring media items based on the prioritized lists received from the clients and based on where particular media items reside; a network, in communication with the server, for transferring the media items pursuant to the schedule, including transferring at least some of the items between clients using peer-to-peer connectivity; and client devices, in communication with the network, for storing and playing back transferred media items.

In yet another embodiment, for example, a method of the present invention is described for delivery of media content available on a plurality of devices having connectivity to one another, the method comprises steps of: determining media items available on each of the plurality of devices having connectivity to one another; receiving priority lists from at least some of the plurality of devices, wherein each priority list represents a prioritized list of media items requested at a particular device; selecting a particular media item to be delivered to a first device based on the priority lists and the media items determined to be available on the first device; identifying at least one second device having the particular media item to be delivered to the first device; and transferring the particular media item to the first device from at least one second device at which the particular media item is available.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a block diagram of a software system for controlling the operation of the computer system.

FIG. 3A is a very general block diagram of the distributed media delivery system of the present invention.

FIG. 3B is a high level block diagram illustrating a preferred set-top box client in further detail.

FIG. 3C is a high level block diagram illustrating the set-top box device of FIG. 3B in more detail.

FIG. 4 is a block diagram illustrating the process for a new user (i.e., new customer) to subscribe to a service for obtaining media content through the system.

FIG. 5 is a block diagram illustrating the process for preparing a client device for delivery to a new client (i.e., new user).

FIG. 6 is a block diagram depicting the activation of a new client device after the user receives and installs the client device.

FIG. 7 is a block diagram illustrating the importation of new items of media content into the system.

FIG. 8A is a block diagram illustrating a user adding media to his or her priority list.

FIGS. 8B-E are bitmap screenshots showing an example of a user's priority list and its use.

FIG. 8F is a bitmap screenshot showing an example of a catalog screen for selecting movies.

FIG. 9 is a block diagram illustrating a user re-arranging his or her priority list.

FIG. 10 is a high-level block diagram illustrating a transfer of media to a client from a media server or another client (peer).

FIG. 11 is a block diagram illustrating the processing of a user request to purchase (or rent) a movie for viewing.

FIG. 12 is a block diagram illustrating the operations of the system in providing an authorization key to client enabling the client to decrypt and play a movie.

FIG. 13 is a block diagram illustrating the secure client boot process that is employed on a client set-top box.

FIG. 14 is a block diagram illustrating the decryption and playback operations at a client device in further detail.

FIGS. 15A-D comprise a series of state diagrams illustrating interaction between the scheduler, a receiving client, and an originating donor/sender client or server in transferring media files.

### DETAILED DESCRIPTION

Glossary

The following definitions are offered for purposes of illustration, not limitation, in order to assist with understanding the discussion that follows.

HomePlug: HomePlug is a networking standard for using existing electrical power lines in homes and offices to network together computing devices. Typically, a HomePlug-compliant device is connected to a computer (e.g., plugged into a USB or Ethernet port) and then into an AC wall jack. The HomePlug device translates the data coming from the computer into a signal that travels over the AC wires, using a different frequency than (and not interfering with) the ordinary current coursing through the same wire. HomePlug uses existing electrical wiring to move data as fast as 14 Megabits per second (Mps). For further description of HomePlug and powerline networking, see e.g., Gardner, S., et al “HomePlug Standard Brings Networking to the Home” available from the HomePlug Powerline Alliance, the disclosure of which is hereby incorporated by reference. A copy of this document is available via the Internet (e.g., currently at www.homeplug.org).

HTTP: HTTP is the acronym for HyperText Transfer Protocol, which is the underlying communication protocol used by the World Wide Web on the Internet. HTTP defines how messages are formatted and transmitted, and what actions Web servers and browsers should take in response to various commands. For example, when a user enters a URL in his or her browser, this actually sends an HTTP command to the Web server directing it to fetch and transmit the requested Web page. Further description of HTTP is available in “RFC 2616: Hypertext Transfer Protocol—HTTP/1.1”, the disclosure of which is hereby incorporated by reference. RFC 2616 is available from the World Wide Web Consortium (W3C), and is available via the Internet (e.g., currently at www.w3.org/Protocols/). Additional description of HTTP is available in the technical and trade literature, see e.g., Stallings, W. “The Backbone of the Web”, BYTE, October 1996, the disclosure of which is hereby incorporated by reference.

MPEG: Short for Moving Picture Experts Group, refers generally to a family of digital video compression standards and file formats developed by the group. MPEG files can be decoded by special hardware or by software. MPEG-4, for example, is a graphics and video compression algorithm standard that is based on MPEG-1 and MPEG-2 and Apple QuickTime technology. Wavelet-based MPEG-4 files are smaller than JPEG or QuickTime files, so they are designed to transmit video and images over a narrower bandwidth and can mix video with text, graphics and 2-D and 3-D animation layers. MPEG-4 was standardized in October 1998 in the ISO/IEC document 14496, the disclosure of which is hereby incorporated by reference.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Network Attached Storage (NAS): Refers to a dedicated network device that provide affordable, easy access to data. NAS allows homes and businesses to store and retrieve large amounts of data more affordably than before. Like traditional file servers, NAS follows a client/server design. A single hardware device, often called the NAS box or NAS head, acts as the interface between the NAS and network clients. One or more disk drives (or other storage devices) can be attached to many NAS systems to increase total capacity. Clients generally access a NAS by connecting to the NAS head (rather than to the individual storage devices) over an Ethernet connection. The NAS appears on the network as a single “node” that is the IP address of the head device.

RAID: RAID stands for Redundant Array of Inexpensive (or sometimes “Independent”) Disks. RAID is a method of combining several hard drives into one logical unit. It can offer fault tolerance and higher throughput levels than a single hard drive or group of independent hard drives.

SAN: A SAN or Storage Area Network is a high-speed subnetwork of shared storage devices. A storage device is a machine that typically contains nothing but one or more disk(s) for storing data. A SAN's architecture works in a way that makes all storage devices available to all servers on a LAN or WAN. As more storage devices are added to a SAN, they too will be accessible from any server in the larger network. In this case, the server merely acts as a pathway between the end user and the stored data. Because stored data does not reside directly on any of a network's servers, server power is utilized for business applications, and network capacity is released to the end user.

Set-top box: The term set-top box (STB) generally refers to a device that enables a television set to receive and decode digital television (DTV) broadcasts. A set-top box is often necessary for television viewers who wish to use their current analog television sets to receive digital broadcasts. More recently, set-top boxes also include a user interface supporting access to the Internet. In this regard, a set-top box can be considered as a specialized computer that can “talk to” the Internet—that is, it contains a Web browser (i.e., a Hypertext Transfer Protocol client) and uses the Internet's main protocol, TCP/IP. The service to which the set-top box is attached may be connected to the Internet through a telephone line as, for example, with WebTV, through a cable television company, or through a broadband connection such as DSL. A typical set-top box contains one or more microprocessors for running the operating system, possibly Linux or Windows CE, and for parsing video transport stream (e.g., MPEG or Windows Media 9). A set-top box also usually includes random access memory (RAM), a video decoder chip, and more chips for audio decoding and processing. The contents of a set-top box depend on the DTV standard used and the other applications offered on the device. More sophisticated set-top boxes contain a hard drive for storing recorded television broadcasts, for downloaded software, and for other applications. Digital television set-top boxes are widely used for satellite, cable, and terrestrial DTV services and are available from a variety of vendors including Sony of Japan, Motorola of Schaumberg, Ill., and Samsung of Korea.

Secure Hash Algorithm 1 (SHA1): SHA1 is used to compute a message digest for a message or data file that is provided as input. SHA-1 is considered secure because it is computationally infeasible to find a message which corresponds to a given message digest, or to find two different messages which produce the same message digest. Any change to a message in transit will, with very high probability, result in a different message digest, and the signature will fail to verify. Further description of SHAL is provided by RFC 3174 which is available via the Internet (e.g., currently at www.ietf.org), the disclosure of which is hereby incorporated by reference.

SSL: SSL is an abbreviation for Secure Sockets Layer, a protocol developed by Netscape for transmitting private documents over the Internet. SSL works by using a public key to encrypt data that is transferred over the SSL connection. Both Netscape Navigator and Microsoft Internet Explorer support SSL, and many Web sites use the protocol to obtain confidential user information, such as credit card numbers. SSL creates a secure connection between a client and a server, over which data can be sent securely. For further information, see e.g., “The SSL Protocol, version 3.0”, (Nov. 18, 1996), from the Internet Engineering Task Force (IETF), the disclosure of which is hereby incorporated by reference. See also, e.g., “RFC 2246: The TLS Protocol, version 1.0”, available from the IETF. A copy of RFC 2246 is available via the Internet (e.g., currently at www.itef.org/rfc/rfc2246.txt).

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is available via the Internet (e.g., currently at www.ietf.org/rfc/rfc793.txt).

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial,” the disclosure of which is hereby incorporated by reference. A copy of RFC 1180 is available via the Internet (e.g., currently at www.ietf.org/rfc/rfc/1180.txt).

URL: URL is an abbreviation of Uniform Resource Locator, the global address of documents and other resources on the World Wide Web. The first part of the address indicates what protocol to use, and the second part specifies the IP address or the domain name where the resource is located.

Windows Media 9: A newer series of codecs developed by Microsoft that provide excellent audio and video quality over a broad range of compression levels. Collectively, these codecs are known as Windows Media 9 Series. They are the foundation of the Windows Media 9 Series platform, which includes programs such as Windows Media Player 9 Series, Windows Media Encoder 9 Series, Windows Media Services 9 Series, and Windows Movie Maker 2. Typically, files encoded using the Windows Media codecs have the file name extensions .wma or .wmv. The former extension stands for Windows Media Audio; the latter stands for Windows Media Video. Information about Windows Media 9 is available from Microsoft Corporation of Redmond, Wash. (see, e.g., www. microsoft.com/windows/windowsmedia/technologies/overview.aspx).

Introduction

Referring to the figures, exemplary embodiments of the invention will now be described. The following description will focus on the presently preferred embodiment of the present invention, which is implemented in set-top, desktop and/or server hardware and software operating in an Internet-connected environment running under an operating system, such as the Microsoft Windows or Linux operating systems. The present invention, however, is not limited to any one particular application or any particular environment. Instead, those skilled in the art will find that the system and methods of the present invention may be advantageously embodied on a variety of different platforms, including Macintosh, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

Computer-Based Implementation

Basic System Hardware (e.g., for Desktop and Server Computers)

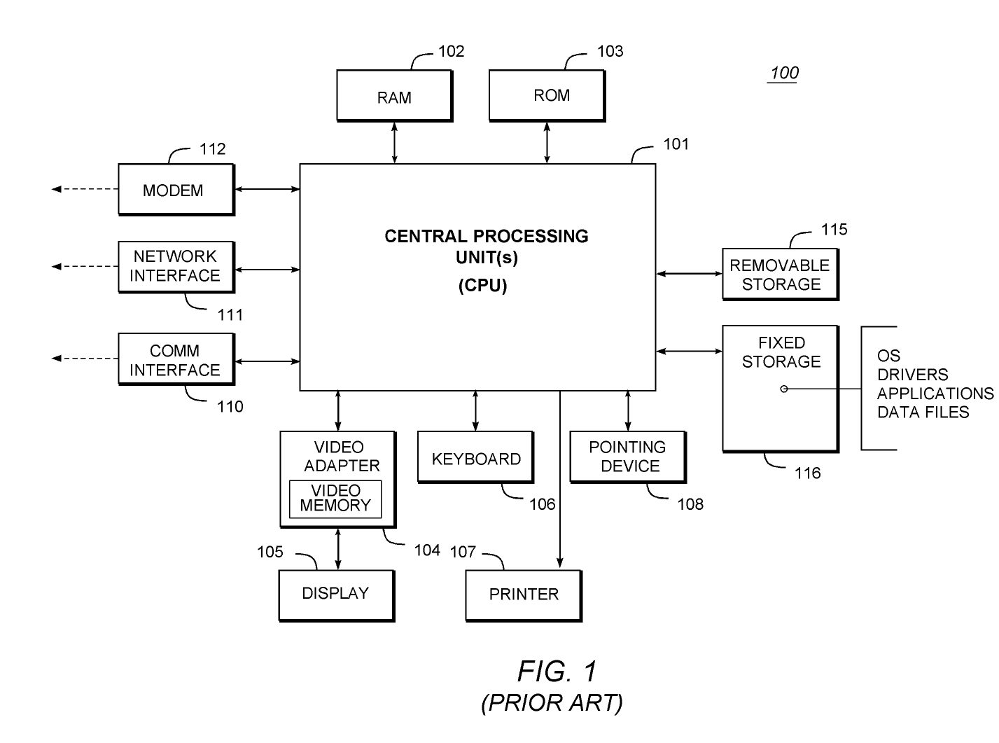

The present invention may be implemented using conventional or general-purpose computer or data processing systems, such as IBM-compatible personal computers (PC), server computers (e.g., UNIX workstation, Linux workstation, or Windows server), set-top box devices, or the like. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

Basic System Software

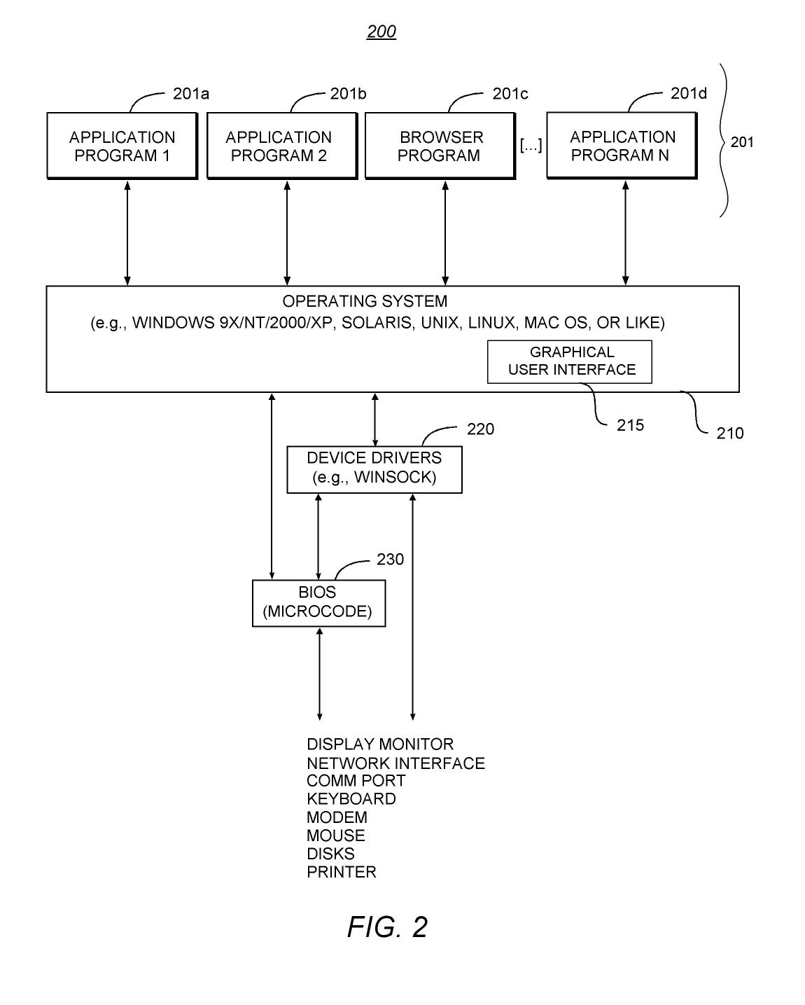

FIG. 2 is a block diagram of a software system for controlling the operation of the computer system 100. As shown, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100. The applications or other software intended for use on the computer system 100 may also be stored as a set of downloadable computer-executable instructions, for example, for downloading and installation from an Internet location (e.g., Web server).

Software system 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft Windows 9x, Microsoft Windows NT, Microsoft Windows 2000, or Microsoft Windows XP, all available from Microsoft Corporation of Redmond, Wash. Alternatively, OS 210 can also be an alternative operating system, such as the previously mentioned operating systems.

The above-described computer hardware and software are presented for purposes of illustrating the basic underlying set-top, desktop, and server components that may be employed for implementing the present invention. For purposes of discussion, the following description will present examples in which it will be assumed that there exists one or more “servers” (e.g., media server) that communicates with one or more “clients” (e.g., set-top boxes or other computing devices). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

Overview of Distributed System and Methodology for Distribution of Media Content

Introduction to Distributed Media Delivery System

The present invention comprises a distributed media delivery system providing a distributed methodology for distribution of media content (e.g., movies or other videos, music or other audio, and other media) via electronic means. The system and methodology of the present invention provides the ability to efficiently deliver digital media selected by a customer from a large catalog or library to the customer's playback device (e.g., set-top box). Unlike prior art pay-per view and/or broadcast systems, a customer can select digital media from a large catalog offering a wide range of choices and watch it at the time of his or her choosing. At the same time, the delivery of the selected digital media to the consumer is performed in a manner that minimizes the total amount of electronic bandwidth and server infrastructure investment required by a supplier (e.g., content provider or service provider), while providing the supplier with the ability to deliver digital media files to its customers within a reasonable period of time.

Client-Side and Server-Side Components

The distributed media delivery system of the present invention combines the use of a client device (e.g., a set-top box or other playback device) in the customer's (user's) home or business, a home network (or LAN) having broadband access to the Internet, and server-side components for delivery of digital media via the Internet using an efficient distributed methodology. At a high-level, the set-top box or other playback device in a customer's home (or business) provides capabilities for storage and playback of digital media (e.g., on a connected television monitor). The set-top box or playback device is connected via a home network (or LAN) and a broadband connection to the Internet to facilitate electronic transmission of digital media to and from the device. The server-side components of the distributed media delivery system include one or more server(s) providing access to a large catalog of digital media. Various security and encryption subsystems are also included for securing the digital media against unauthorized access. Another component is a customer management subsystem which tracks customers and manages customer account information. In addition, a scheduler determines how media should be sent to a customer, including how and from where it should be sent.

Delivery of Media Content to Customers

From a customer point of view, once the customer subscribes to obtain digital media through the distributed media delivery system, he or she can select movies and other digital media from a wide range of available titles. The customer can also assign priorities to the selected media to create a prioritized list (or “priority list”) of media that he or she wishes to obtain. It should be noted that the customer is unlikely to have all of the selected movies or other media on his or her priority list available immediately. Instead, the priority list represents a list of the media (e.g., movies) that the customer would like to receive in the future as soon as possible. The list may be longer and require more storage capacity than the user's playback device or home network actually has. The items on the list that cannot fit on the playback device represent the items in priority order that the user would like to see delivered in the future as room is made available on their STB. It also serves as a memory aid. In the event that there is sufficient bandwidth to transfer files from nodes to STBs as fast or faster than playback speed, the priority list plays the role of personal menu and playback is immediate. In that case, media is playable directly from the catalog list on the STB.

Once the customer has created a priority list, the distributed media delivery system proceeds to download the content on the priority list to the customer's playback device (e.g., set-top box). The system directs the content selected by the customer to be downloaded to the customer's set-top box via a broadband Internet connection to the customer's home network as hereinafter described. The approach of the present invention is to deliver all media content in an encrypted format to ensure it is only used in an authorized fashion. The media content that is distributed and stored by the distributed media delivery system is securely encrypted on the media servers and playback devices as well as during distribution via the Internet. The transfer is also verified to guarantee that a correct and uncorrupted copy of the file is delivered. When a user actually wants to watch a movie on the priority list that has been delivered, he or she can simply hit a “play” button or similar control to initiate playback. In response, the customer management subsystem is queried to determine if the customer's account is in good standing and that other conditions are satisfied. If so, the system sends an authorization key to allow the media to be decrypted and played. A customer generally does not have the effective ability to access and use (i.e., play) the media until an authorization key is received.

Scheduling of Content Delivery by the Distributed Media Delivery System

Behind the scenes, the distributed media delivery system's scheduler monitors the priority lists of all customers and the media content actually present on customers' playback devices (set-top boxes). Based on this information, the scheduler arranges for media content to be delivered to where it is needed either from the distributed media delivery system's servers (the original repository for storing media content) or from another customer that has a copy of the desired media content. The scheduler determines which movies (or other content) should be delivered to each customer and then decides the manner in which the content should be supplied. Rather than sending all media directly from a supplier's servers, which requires the supplier to utilize both a large number of servers and significant network bandwidth, the supplier's resource burden is reduced as customer nodes are used to send media files among themselves. However, unlike traditional peer-to-peer (“P2P”) methods, the customer is not forced to search other peers for copies of the desired media and initiate a download. Instead, the system makes the appropriate arrangements for delivering copies of the media on the customer's priority list, with copies delivered either from a peer or from the central repository as determined by the system's scheduler.

Advantages of the Present Invention

The distributed media delivery system of the present invention allows for the delivery of digital media files, via a digital network (wired and/or wireless) using a distributed file system that minimizes centralized server resources and maximizes the use of “peer nodes” (i.e., the customer playback devices). Unlike free-wheeling P2P file delivery systems (e.g., Napster), the distribution of media files is centrally controlled by the distributed media delivery system's scheduler and presents the available items of media content to customers as a consistent catalog of available titles. This is possible because at least one copy of each available title is kept on the content provider's file server(s) (or a network of servers). Additional copies, based on demand, are stored on the distributed peer nodes. It should be noted that the “peer nodes” typically comprise set-top boxes, although in some cases a peer node may be a file server (e.g., personal computer or Network Attached Storage (NAS)) located on a customer's home network. The distributed media delivery system of the present invention is differentiated from P2P systems in the way that the users of the service are presented with a single instance catalog of all available titles, and that when a title is selected the file distribution methodology of the system delivers the requested file from the best available resource within what is effectively its own virtual private network. In this manner distribution of media files can also be optimized by the system's scheduler on a system-wide basis. Also, the system verifies that the files are correct copies and not corrupted in any way to avoid viruses and other system interruptions. In contrast, prior P2P systems require users to search for items of interest on an ever changing network of nodes and therefore do not provide users with a consistent “catalog” from which to choose.

The advantages of the present invention include that the total cost of running the distributed media delivery system is low since bandwidth and storage costs are shared with customers. In particular, the number of servers required is low compared to Internet downloading methods, cable or Internet server VOD, involving delivery of copies or streaming from a central set of servers. As described above, prior art systems for delivery of videos have generally provided only a limited number of titles to consumers (e.g., a limited number of broadcast or cable television channels or a limited selection of videos on demand) in large part because of bandwidth limitations. However, even in the event that available network bandwidth increases considerably to enable delivery of a larger selection of media, the prior art approach providing for serving all media files from a centralized system is still disadvantageous as it would require a tremendous number of servers and supporting infrastructure to serve all of this media to customers. The approach of the present invention, in contrast, spreads a considerable portion of this burden across a large distributed network of customers, by shifting most of the burden of media delivery away from servers and onto peer-to-peer connected consumer devices.

The use of a priority list also ensures that customers should always have a number of movies available for playback. In the currently preferred embodiment, the act of choosing a movie (or list of movies) is separated from the viewing (playback) process. Generally, unless a customer has recently made changes to his or her priority list, the higher priority items on the priority list will be available locally (i.e., already stored on the local playback device or home network). The items that are in process of being delivered will typically be those of lower priority towards the end of the priority list. This enables the customer to watch the top priority movies on the priority list at his or her convenience, without having to wait for delivery. This is in contrast to video on demand, PPV, and other such systems which offer only a limited number of selections at one time and which couple delivery and viewing of the media.

In addition, the present invention provides a reliable system delivering high-quality content to customers. Media (e.g., movie) quality is high as high fidelity media files are transferred for storage and playback from hard disk. Playback of high fidelity movies from a hard disk, today, provides a much better viewing experience to customers than Internet streaming approaches. Also, the distributed media delivery system is reliable because it is structured with built-in redundancy: copies of media files are available from a large number of peer nodes rather than one centralized repository. Also, in the currently preferred embodiment, the peer nodes are typically configured to be dedicated to the system and therefore provide a fault-resistant infrastructure that is available on a 24 hours per day, 7 days per week basis. The priority list behaves like a personal VOD menu, as a subset of the entire catalog. This makes playback selection much easier and manageable. It also serves as a memory aid to assist in recalling media that the user had once expressed a desire to view.

It should be noted that the distributed media delivery system of the present invention is useful both in limited bandwidth scenarios and in situations where there is substantial available bandwidth. When there is limited bandwidth, the system provides for download and then playback of media files. This provides the benefits of (a) lower system operator bandwidth, (b) lower server infrastructure, and (c) high quality playback. In the event that there is substantial available bandwidth, then the system can instead deliver the files in real-time for immediate playback either from a client or a media server. In this case, the system provides the benefits of lower system operator bandwidth and lower server infrastructure, with the user's priority list serving as a personal menu of content that the user is interested in viewing. The system then behaves like a client-server VOD system but with much lower cost and higher reliability.

Security concerns of content providers are also addressed as all media content is stored in encrypted form and delivery is controlled by the distributed media delivery system's scheduler. The system's scheduler keeps track of every piece of media and does not permit viewing without specific permission which is provided by way of an authorization key. Distribution of content is also controlled by the scheduler and copies are only provided to authorized customers. Security also includes verifying that correct and uncorrupted files have been delivered. The components of the distributed media delivery system will now be described.

System Components

Overview of Distributed Media Delivery System

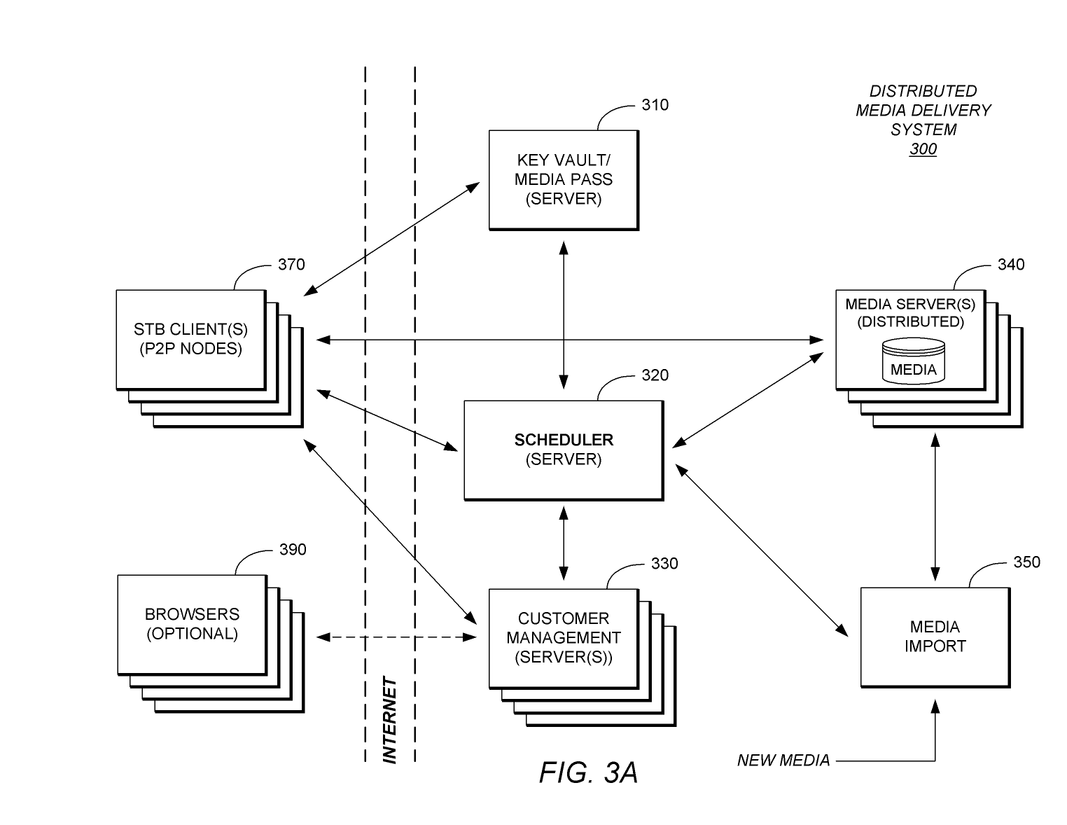

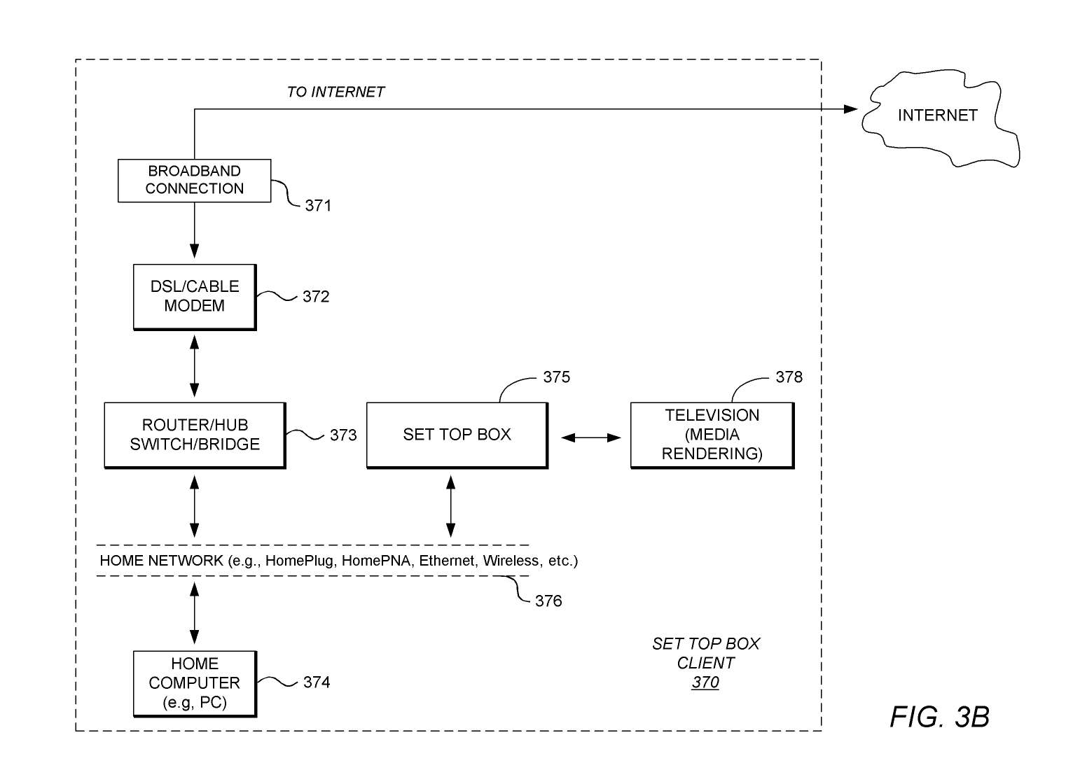

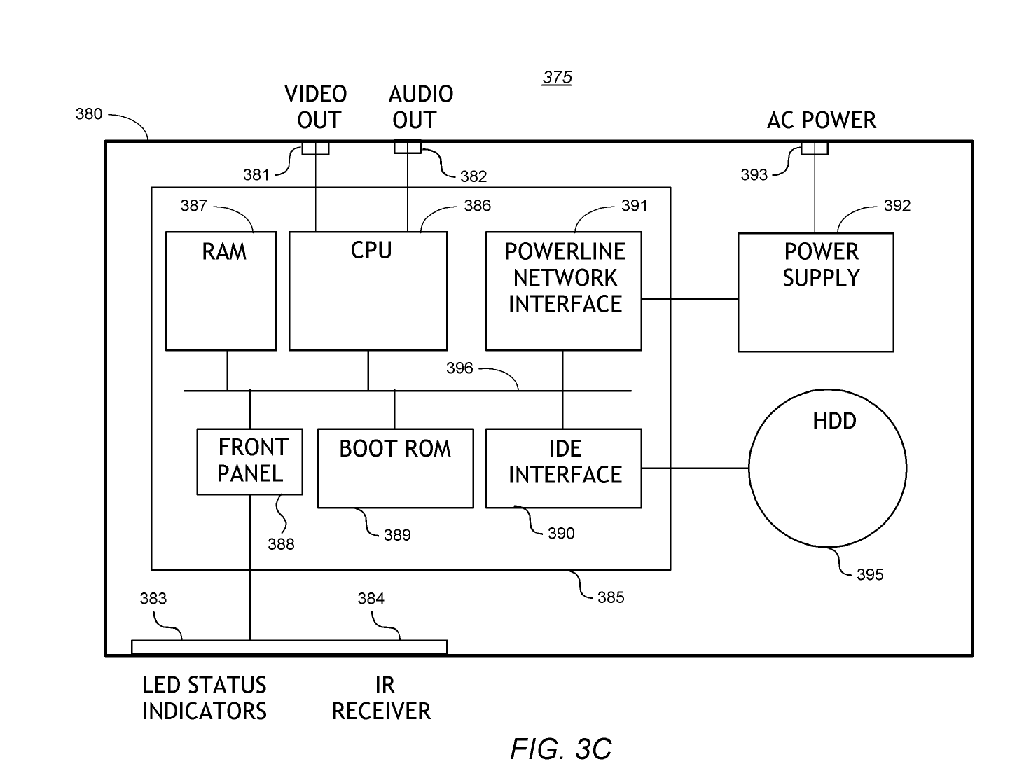

FIG. 3A is a very general block diagram of the distributed media delivery system 300 of the present invention. As shown at FIG. 3A, the components of the distributed media delivery system 300 include a key vault/media pass (server) 310, a scheduler (server) 320, one or more customer management (server(s)) 330, one or more media server(s) 340, a media import module 350, one or more set-top box (STB) client(s) 370, and (optionally) one or more browser(s) 390. As shown, in typical operation a plurality of set-top box clients 370 will receive content through the distributed media delivery system 300 of the present invention. Similarly, multiple media servers 340 (or networks of distributed media servers) may be employed for storing encrypted media content and supplying the encrypted media content to the STB clients 370. The components of the distributed media delivery system 300 communicate with each other through one or more network(s), which may include communications via one or more wide area networks (e.g., the Internet) and/or one or more local area networks (e.g., a home network or other LAN). Generally, communications between system components are encrypted and components are authenticated before communications are exchanged. Each of the components of the distributed media delivery system will now be described in greater detail.

Client-Side Components

The set-top box (STB) clients 370 are typically located in user (customer) home or business locations and provide media decryption and playback to users. FIG. 3B is a high level block diagram illustrating a preferred set-top box “client” 370 (i.e., STB deployment environment) in further detail. As shown, the set-top box client 370 may be deployed in an environment that includes a set-top box 375 connected to a television 378 and a home network 376. The set-top box 375 is connected via the home network 376 to a router/hub (switch/bridge) 373 which, in turn, is connected to a DSL or cable modem 372 providing access to the Internet via a broadband connection 371. Optionally, a home computer 374 is also connected to the home network 376. Each of these components of the client 370 will now be described.

In the currently preferred embodiment, the set-top box 375 comprises a set-top box (STB) or other playback device having a hard disk (or other permanent electronic storage such as flash memory) for storing and playing copies of media files locally at a user's home (or office). In the presently preferred embodiment the set-top box 375 preferably includes a hard disk of 40 gigabytes or more for storing media files. However, in an alternative implementation the set-top box 375 may or may not have storage built into it, and has access via a LAN or USB or similar high speed local connectivity (e.g., home network 376) to a storage device (e.g., home computer 374) that can feed the playback device (i.e., set-top box 375) fast enough to provide a high quality video playback. In this alternative embodiment, the storage device (e.g., home computer 374 or NAS) may serve one or more playback devices connected through the home network 376 in a home or business. As another alternative, the set-top box 375 may comprise a general purpose computer running the appropriate software.

In a typical implementation, the set-top box 375 is connected directly to a television or other display device 378 for rendering media as shown at FIG. 3B. The set-top box 375 also includes network connections for connection to a home network 376 (e.g., HomePlug, HPNA, Ethernet, Wireless, etc.). The home network 376, in turn, typically provides connectivity via a router/hub 373 (or switch/bridge) and a modem 372 (e.g., DSL, satellite, or cable modem) to the Internet via a broadband connection 371. When the user selects a video (or other item of content) and hits “play”, the set-top box 375 communicates through these networking components to communicate via the Internet with other components of the distributed media delivery system 300 to obtain the authorization (decryption) key necessary to decrypt and play the video on the user's television or display device.

The set-top box 375 is also responsible for presenting a user interface to the user which enables the user to perform various actions including: a) searching/browsing the user's priority list of video files; b) searching/browsing the media catalog; c) selecting new media to be added to the user's priority list and re-ordering the priority list; d) removing media from the priority list; e) selecting media (e.g., video) from the priority list for playback; and f) system setup and maintenance. The user interface typically includes a display for presenting information to the user (e.g., on-screen on a television or other display device 378) as well as an input device (e.g., remote control, mouse, keyboard, or the like not separately shown at FIG. 3B) for the user to make selections. The information stored by the set-top box 375 includes current client status, catalog of media meta data, current media transfers, status of client media (including priority rank, decryption keys, etc.), and encrypted media available on the client (e.g., video media). The set-top box 375 also runs software that communicates via the home network and other components of the client 370 with the scheduler 320 and other components of the distributed media delivery system as hereinafter described (e.g., for obtaining an authorization key to decrypt and play media available locally).

FIG. 3C is a high-level block diagram illustrating the set-top box device 375 of FIG. 3B in more detail. As shown, the set-top box device 375 includes a case 380 containing a power supply 392, a hard disk drive 395, and a main board (motherboard) 385. The motherboard 385 houses a CPU 386, a random access memory (RAM) 387, a front panel 388, a boot ROM (read only memory) 389, an IDE interface 390, and a powerline network interface 391 which are connected via a system bus 396. Other components of the set-top box 375 include a video out line 381 and an audio out line 382 connected to the CPU 386, an AC power line 393 connected to the power supply 392, and an infrared (IR) receiver 384 and LED status indicators 383 connected to the front panel 388. Each of these components will now be described.

The case 380 houses the other components of the set-top box 375 and includes connections providing for connectivity to external devices such as a television, home stereo, and a power outlet (not shown at FIG. 3C). External connectivity is provided via a video out line 381 for connection to an external display device (e.g., a television), an audio out line 382 for connection to an external audio device (e.g., a television or home stereo), and an AC power line 393 for connecting the set-top box 375 to an AC wall jack and into a home network via the powerline network interface 391. Also mounted on the case 380 is an IR receiver 384 for receiving input from an external remote control or similar device (not shown at FIG. 3C) and LED status indicators 383 for providing status indication and feedback to the user. In its presently preferred embodiment, the set-top box LED status indicators 383 include one LED status indicator for indicating network connectivity and another for indicating whether the power is on. The IR receiver 384 operates in conjunction with an external remote control or similar device to enable the user to issue commands to the set-top box (e.g., to request playback of a movie). A conventional consumer electronic remote control device having an infrared transmitter may be used for these purposes.

The motherboard 385 is based on a Starfish board available from Equator Technologies, Inc. of Campbell, Calif. A primary component of the motherboard 385 is the CPU 386. The CPU comprises an Equator BSP-15 processor, which is a programmable system-on-a-chip (SoC) processor designed for video and signal processing applications. The Equator BSP-15 processor includes host processor functionalities with media processing capabilities, SDRAM and PCI interfaces, a DES engine, and a multimedia I/O system. The on-chip hardware DES engine provides DES and 3DES encryption or decryption. As described below, the integration of DES processing with video processing allows one-chip handling of protected content, without clear-text streams passing chip-to-chip. The Equator BSP-15 produces S-Video, composite video (CVBS), and component analog video output (e.g., for output via the video out line 381). It also produces a stereo analog audio output and digital audio output (e.g. for output via audio out line 382).

Other components of the motherboard 385 include the boot ROM (read only memory) 390 comprising NOR flash memory. Also included is system RAM (random access memory) 387 providing working memory for the system. Additional components on the motherboard 385 include a front panel 388 and an IDE interface 390. The front panel 388 comprises interface electronics which provide for communication with the LED status indicators 383 and infrared (IR) receiver 384. The IDE interface provides for PCI to IDE connectivity to the hard disk drive (HDD) 395.

In addition, the Starfish board includes a Realtek RTL 8100 Ethernet interface, which is a standard Ethernet adapter. In the currently preferred embodiment of the set-top box 375, this interface is modified to provide for a powerline network interface 391 which provides for connectivity to a home network through the power supply 392 and AC power line 393. In the presently preferred embodiment, the powerline network interface 391 is implemented using an Intellon INT5130 chip set (or alternatively an Intellon INT51X1 chip set) available from Intellon Corporation of Ocala, Fla. In addition, the power supply 392 is a standard power supply that is modified by creating taps (e.g., using an analog module inside the power supply) off the power that is coming in from the external power source for connecting to the motherboard through the powerline network interface 391. The powerline network interface 391 then converts the signal in standard format for communication with the CPU 386 via the bus 396. In an alternative embodiment, the RTL 8100 Ethernet adapter supplied as part of the Starfish board may present an Ethernet interface at the back of the set-top box 375 which may then be connected to an external powerline network component (e.g., a Netgear wall-plugged Ethernet bridge model XE102) for connecting into a home network via a powerline.

The hard disk drive 395 comprises a conventional hard disk drive for storage of encrypted media files and other information. Preferably, a hard disk drive with a capacity of at least 40 gigabytes or more is employed. Hard disk drives suitable for use in conjunction with the present invention are available from a number of vendors, including Western Digital of Lake Forest, Calif. and Seagate of Scotts Valley, Calif.

The set-top box 375, in its presently preferred embodiment, runs the Linux operating system (available from several vendors) and application software (not separately shown at FIG. 3C). These software components include modules for display of a user interface to the user (e.g., on screen on the television) for setting priority lists, playing movies, and performing other such functions. In addition, software modules are included for communication with the scheduler and other server and peer components to implement the methodology of the present invention as described below.

Media Servers

The media server(s) 340 are the suppliers of items of media content, in encrypted format, to the client(s). The media server(s) 340 store encrypted video media; the scheduler stores the meta data for that media. Media servers are similar to clients when considering file transfer. The main difference is that a media server is not intended to playback media and it is expected to be able to serve many more nodes than a client would normally be expected to serve. Any node can deliver to any other node. In that regard, servers and clients are similar. This is useful for provisioning files to multiple servers. As shown at FIG. 3A, the media server(s) receive media content when items are initially uploaded into the distributed media delivery system 300 through the media import module 350 (prior to any clients receiving the media content via the system). The media server(s) 340 comprise at least one file server storing at least one copy of each media file that is made available through the system. The media server(s) 340 are standard servers (e.g., Linux-based servers) running software for communication with STB client(s) 370 or other media servers and taking direction from the scheduler 320. The media server(s) 340 typically have a large storage capacity and a broadband connection to the Internet (e.g., a T3 connection). Those skilled in the art will appreciate that the media server(s) may be implemented in a number of different ways. For example, the media server(s) 340 may be implemented as a single server with a massive array of hard disk drives (e.g., a RAID configuration). An alternative implementation may include clusters of servers sharing a SAN (Storage Area Network) of massive disk storage.

The presently preferred embodiment includes several distributed clusters of media servers, each with a SAN (or equivalent massive hard disk capacity). Preferably, each cluster of media servers is located in a different physical network operations center in a different geographic location. In the preferred embodiment, each cluster of media servers 340 stores a subset of all of the media files represented in the distributed media delivery system 300 such that a subset (m of n) of the total servers has at least one copy of each file among them. For example, the system may have a total of 5 media server clusters 340 with files distributed to each cluster such that any 3 of the 5 server clusters would provide a superset of the entire media file database (i.e., the entire set of media files). This configuration provides for system-wide redundancy and uptime reliability yet reduces overall storage requirements.

Customer Management Server(s)

The customer management (server(s)) 330 (CMS) handles customer interaction including initial sign-up, account management, media list management, and playback authorization. The customer management server(s) 330 stores customer account information. The customer management server(s) 330 is currently implemented as a Web server (e.g., an Apache web server) that dynamically creates the Web pages necessary for interaction with users (e.g., via a Web browser and/or the user interface presented by the client). The customer management server(s) 330 currently includes the following functions: a) new account creation, including sign-up by supplying name, address, credit card, and so forth; b) account management; c) display of media file database information; d) selection of media files to be added to a user's priority list; e) reordering of priority lists; and f) authorization of media playback. Users may interact with the customer management server(s) either through the STB clients 370 or through Web browsers 390 (i.e., without using the STB clients 370). In this regard, a user is not required to use the set-top box to decide what selections are to be added to his or her priority list and so forth, and can instead interact with the customer management server(s) 330 from a different location through the Internet (e.g., using a Web browser from a home or business PC connected to the Internet). The customer management server(s) 330 also keeps track of how many playback devices individual users have associated with their accounts as well as information regarding the supplier of each playback device (STB). In a configuration where the customer management server(s) 330 comprise a plurality of servers, each given server may be controlled by or licensed to a particular entity (e.g., specific motion picture studio). The scheduler can communicate with and support multiple customer management servers, each having their own URL and catalog(s). In this configuration, the user interface on the client set-top boxes is also enhanced to include an additional screen/page to display the priority list for a particular customer management server or catalog. This is an important capability because it allows multiple content vendors to operate independently of each other, yet take advantage of the system's delivery and authorization/playback infrastructure.

The customer management module also operates in conjunction with a media file database (not separately shown at FIG. 3A) which stores information about each item of media content, including genre, date released, actor(s), director(s), producer(s), and the like. In the presently preferred embodiment, the media file database is embodied using the MySQL open source database (available from MySQL AB of Uppsala, Sweden). However, other databases or file systems (e.g., from Oracle, Sybase, IBM, and Microsoft) may also be used for implementing the present invention, as desired. Whenever a new item of content (e.g., audio, video, text, still images, etc.) is made available in the catalog, the available information is entered into the media file database. This information is used by the customer management server 330 to populate dynamically rendered Web pages when a user visits the online catalog.

Customers (users) may search/browse the media catalog maintained by the customer management module using either a Web browser 390 connected to the Internet or using the user interface of the client (i.e., the client STB 370). While browsing, a customer may select and add media files from the catalog of available titles to his or her priority list. The customer may also assign priorities to the files on the list. For example, the customer may select a total of 20 media files and rank them in order from “1” (being the highest priority) to 20 (being the lowest priority). The customer may also re-order the priority of files on the priority list from time to time, as desired. The priority list is used by the scheduler 320 to determine the order of content delivery to the client. On the STB client 370, the priority list forms a convenient, custom menu for the user to select a video (or other media) to play. In the currently preferred embodiment, an indication is provided as to whether titles on the priority list are available on the STB client 370 (i.e., have been delivered). In the case where sufficient server-to-client or client-to-client bandwidth exists, the list and catalog may also indicate that files are immediately playable.

As an optimization, the information about media files in the media file database associated with the customer management server 330 is also used to populate a database of the same information that is copied to the STB client(s) 370. These client databases are usually updated shortly after the media file database is updated. The media file database is replicated to the STB client(s) 370 for the local playback environment in order to reduce server load, reduce bandwidth needed to communicate to the database server, and improve user interface performance at the client(s). The database information can be distributed to the STB client(s) 370 either item by item via the scheduler 320 through messages to the client, or in bulk through the use of the same mechanism the distributed media delivery system 300 uses to distribute the media content itself.

Scheduler

The scheduler 320 communicates with other components to perform functions relating to scheduling the actual delivery of media to client(s). The scheduler 320 maintains media meta data, information regarding decrypt keys provided to STB clients 370, system-wide transfer information, information about STB clients 370, and each client's media status. These scheduling functions include, for example, determining the time of delivery, the selection of the source of the delivery, and so forth. The scheduler 320 includes a module for communications with each client and also maintains a scheduling database (not separately shown at FIG. 3A) with entries for each STB client 370. In the presently preferred embodiment, the scheduling database is embodied using the MySQL open source database (available from MySQL AB of Uppsala, Sweden). However as was the case with the media file database, other databases or file systems (e.g., from Oracle, Sybase, IBM, and Microsoft) may also be used for implementing the scheduling database of the present invention, as desired. The scheduler 320 tracks each media file that is present on each STB client 370 and stores related provisioning information. The scheduler 320 provides services for the STB client(s) 370 and also controls many of the functions of the set-top boxes of the STB clients 370. The operations of the scheduler in scheduling delivery of media files is described in more detail below.

Key Vault/Media Pass Servers

Another component of the distributed media delivery system is the key vault/media pass server(s) (“key server(s)”) 310 which is responsible for providing authorization keys to STB clients(s) 370 to enable decryption and playback of media files. The information maintained by the key server(s) 310 includes media decryption keys and media passes. The key server(s) 310 are currently implemented as a pair of servers using SecureMedia's Encryptonite product (available from SecureMedia of Natick, Mass.). The Encryptonite product uses an encryption scheme based on the Diffie-Hellman cryptographic mathematics algorithm; however, those skilled in the art will appreciate that a number of other encryption algorithms may be employed for encrypting the media files. As described below in greater detail, obtaining access to the files involves two layers or sets of operations. First, a client desiring access to media must gain permission to obtain a key which enables decryption and playback of a media file. During this process, various business rules are evaluated by the system's customer management server(s) 330 to determine whether the STB client 370 that is requesting access should be provided with the requested access. When permission is granted, the STB client 370 is issued what is called a “media pass”. After the client receives the media pass, the STB client 370 initiates the second set of operations by requesting the decrypt/playback key from the key vault/media pass server(s) 310 and providing a copy of the media pass. The key server(s) 310 provides the actual key which enables the client to decrypt and play the media file. The operations of the scheduler 320 in delivery of media to clients will next be described in greater detail.

Scheduling of Delivery of Media Files

Scheduling of Deliveries from Servers and Peers

The scheduler is responsible for determining which clients should receive media and how and when it should be delivered. The scheduler refers to a user's priority list to determine which files need to be delivered to the user. The scheduler also consults the above-described scheduling database to determine where copies of the needed media files are located. The scheduler will select how the media file should be delivered to a particular client (STB) based on several factors, including the availability of the needed file on other clients in the network. When configured to reduce the supplier's (i.e., distributed media delivery system operator's) server and bandwidth load, the scheduler will, whenever possible, direct a client to fetch its next needed media file from another client. However, if the supplier prefers to source files for delivery from its own media servers, the scheduler can be set to prioritize delivery from these sources instead. In contrast to prior peer-to-peer approaches which typically required the client wishing to obtain media to look at other peer nodes to find and attempt to obtain the desired media, the scheduler of the present invention performs these tasks in an intelligent, automated fashion.

Measured Performance of Communications

In making scheduling decisions, the scheduler also considers the measured performance of the communications between and among the media servers and the clients. This information is kept up to date (e.g., in the scheduling database associated with the scheduler) so as to provide near-real-time information concerning latency and throughput of data from the media servers to the clients and vice versa. In addition, as clients transfer files among themselves, the latency and throughput information is captured and communicated back to the scheduler from time to time by each client.

Priority List Analysis

In addition, the scheduler performs an analysis of the priority lists of existing users, as well as the scheduling database of files that have already been delivered to each user's client device, to determine which files are likely to be most needed. The scheduler can also use this information to assure that there will be at least one copy of each file among the client STBs in the network of users. This can be done at the initial setup (e.g., before the client device is supplied to the user) or later after the client has been setup and connected to the network by the user. To speed up the process of pre-copying files onto the hard disk of the client STB, a standard disk image, or possibly several different ones, can be used to initialize client hard discs as they are being manufactured. These disk images can be updated from time to time based on the scheduler's analysis of most likely needed media files (e.g., the movies most likely to be selected by new users) by inspection of all users' current priority lists and knowledge of soon to be release new media items. Then, at final initialization before delivery of the client STB to the customer or after initial setup of the client, only the files that do not match the predicted set need to be replaced.

“Shadow Priority List” Maintained by Scheduler

In effect, there are two priority lists maintained by the scheduler for each user. The first is the visible list that is shown to the user as being the files available on their STB and immediately ready for playback. The second is a “shadow priority list” which is a list created by the scheduler for its benefit for the following purposes: a) to ensure that every file stored on the media server(s) has been copied onto at least one STB in the user network; b) to make available additional copies predicted by the scheduler to be needed to perform peer to peer (client to client) file deliveries; and c) to pre-deliver the files that are currently on a user's priority list but have not yet been delivered so that they will perceive a high quality of delivery service (i.e., the user perceives that new files arrive quickly). Specifically, if an STB has capacity for 40 media items, for instance, the scheduler could arrange for delivery of 30 items that would display as “delivered” in the priority list and leave room for 10 more items that would only display as “delivered” in the event that one of the items was on the extended user priority list and the user had discarded one of the initial 30 items. This shadow list provides the system operator caching space to make sure that adequate copies of media items are available throughout the network.

In the event that a user does not make selections for the priority list, or the user's STB can store more files than they have selected for their list, the scheduler can direct the delivery of files that are likely to be of interest to that user. This information is derived from ratings of previously viewed content, by having the user indicate a preferred genre, or other such means.

Initiation of Transfers

The scheduler is also capable of initiating transfers, in either direction between clients, where one of the clients cannot initiate the communication with the other. In that event, the client that can initiate communication contacts the other client. Once the connection has been made, a file transfer can take place in either direction. The scheduler specifies to the clients which one shall initiate the communication and which client will transfer the file to the other client. Also, in the event that there is asymmetric network bandwidth between clients, the scheduler may instruct more than one client, up to the maximum receiving bandwidth of the receiving client, to transfer media to the receiver. The scheduler dynamically determines the amount and what portion of a file should be transferred from the sending client (or server) to the receiving client and keeps track of what portions of the file have been transferred. It can use this technique to effectively “create” bandwidth. Once a portion of a file, however small, has been transferred from one client to another, that portion immediately becomes available for transfer to yet another client. With each new client that receives the small file portion, its outbound bandwidth to other STBs in the network becomes available for sending that file to other clients in the user network. This approach significantly reduces the needed centralized server capacity in terms of network communications and outbound bandwidth, in exchange for some latency of the time for delivery of the file (based on the number of users plus the time it takes to deliver the file and to setup the delivery process). This approach allows a system operator to deliver a single file to every user node inexpensively yet within a reasonable delivery period. Also it should be noted that as bandwidth between peer nodes increases, the network delivery time decreases.

Detailed Operation

Operations of Distributed Media Delivery System

The operations of the distributed media delivery system will now be described in detail. The following discussion illustrates the typical operations that may be involved for a user to subscribe to a service employing the system and methodology of the present invention and to receive and play items of media content through the use of the distributed media delivery system. The following description presents method steps that may be implemented using computer-executable instructions, for directing operation of a device under processor control. The computer-executable instructions may be stored on a computer-readable medium, such as CD, DVD, flash memory, or the like. The computer-executable instructions may also be stored as a set of downloadable computer-executable instructions, for example, for downloading and installation from an Internet location (e.g., Web server).

New User Subscription

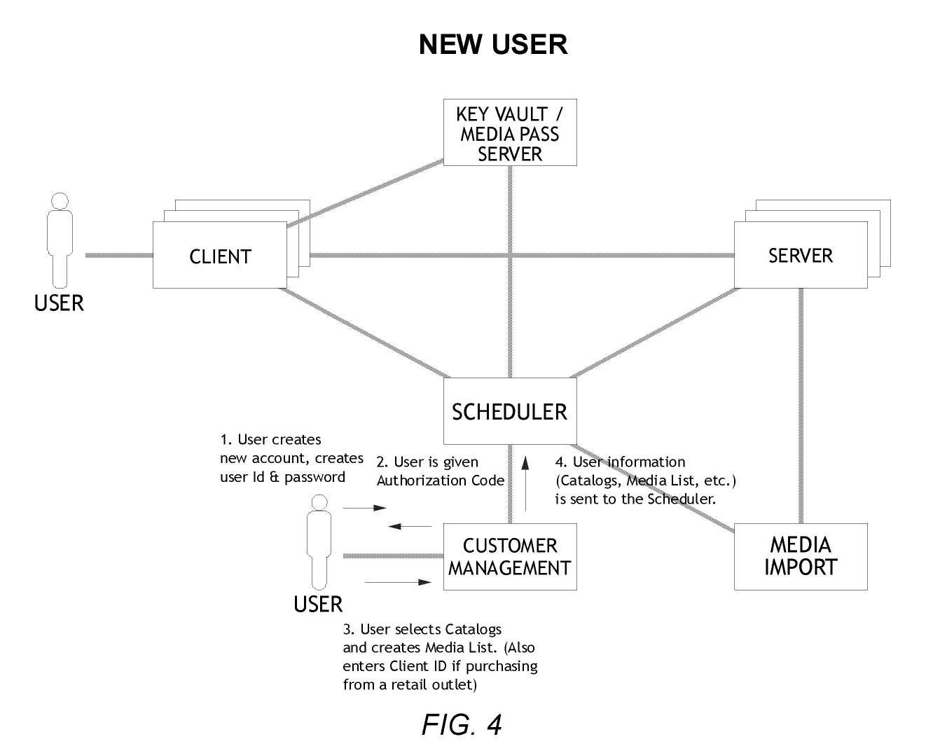

FIG. 4 is a block diagram illustrating the process for a new user (i.e., new customer) to subscribe to a service for obtaining media content through the distributed media delivery system. The user may subscribe by purchasing a client device and subscription at a retail store or by signing up directly with the supplier through the Internet. For example, the user may visit a supplier (e.g., ALIO TV) Web site using a Web browser to subscribe to the service. As shown at (1) in FIG. 4, a user creates a new account by choosing a user ID and password and entering other personal information (e.g., credit card/payment information). After the account is created, at (2) the user is supplied with an authorization code. As shown at (3) in FIG. 4, the user may select one or more catalogs and create a media list (or priority list). It should be noted that there may be more than one catalog offered to users. For example, one catalog may include movies from a particular movie studio, while another catalog covers movies from a particular country (e.g., movies from China or India). Importantly, the user may also create an initial priority list of media content (e.g., videos) that he or she would like to view.

A user may create a priority list by searching or browsing one or more catalogs (e.g., a movie catalog) available via the Web site customer management system interface. In the currently preferred embodiment, the catalog(s) and Web interface is implemented as a database driven, hence dynamically created, set of Web pages, driven from the information in the media file database (as described above). In the currently preferred embodiment, the customer management Web server is implemented using an Apache web server available from The Apache Software Foundation. Information about each movie is available to search, browse, sort, and view. The information that is searchable includes, for instance, titles, year introduced, actors, directors, producers, genre, and so forth. A user can select a list of media items and assign priorities to each media item in order to express the preferred order in which the user would like the media files to be delivered and made available for his or her viewing.

After the user supplies this information, as depicted at (4) at FIG. 4, the user information is sent to the distributed media delivery system's scheduler. As noted above, the system's scheduler will use this priority list to “fill up” the user's available storage (i.e., the storage available on the client device assigned to the user). At this point a client device (e.g., set-top box or other playback device) may or may not have been received by the user. For example, a user purchasing a set-top box at a retail outlet may perform the above steps to subscribe to receive media content after purchasing the set-top box at a retail store (or even during the purchase process at the retailer). However, a user purchasing the client device (STB) through the supplier Web site will obviously not yet have the client device.

Preparing Client Device for User

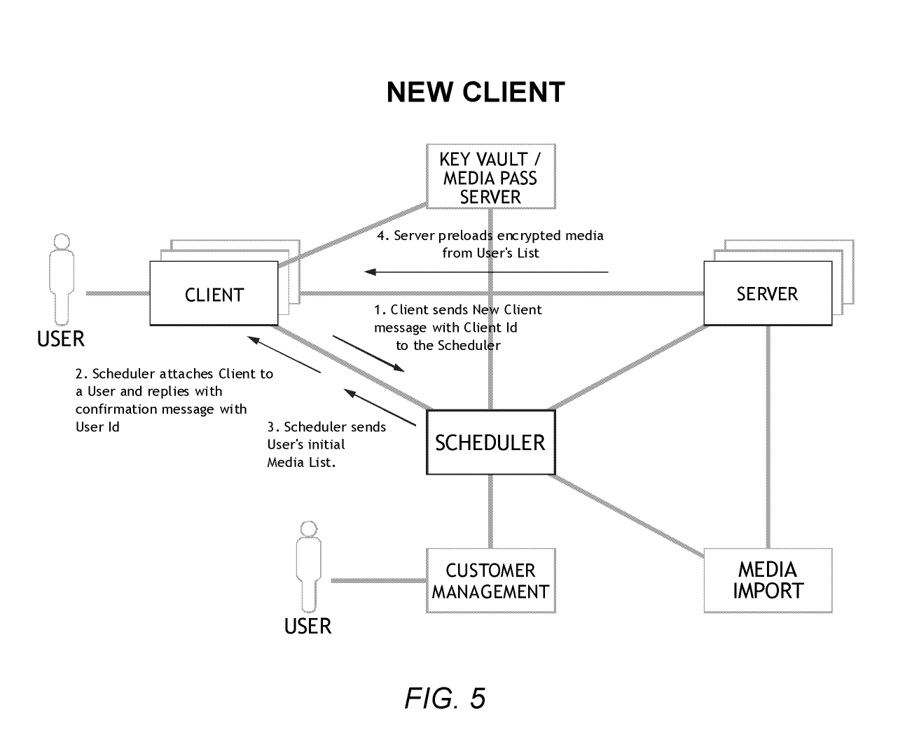

If the user is purchasing the client device through the supplier Web site, when the user has completed the sign up process, the user record is flagged to indicate that a set-top box needs to be prepared and sent to the user. FIG. 5 is a block diagram illustrating the process for preparing a client device for delivery to a new client (i.e., new user). As shown, a new client message with a customer ID is received by the scheduler at (1) at FIG. 5. The scheduler attaches (i.e., assigns) a client device to the customer and replies with a confirmation message to the client at (2) at FIG. 5. At this point, the client device (STB) is assigned to a specific user and assigned a unique ID, or if the STB has a method of deriving or determining its own unique ID, that ID is sent to the scheduler as a means to uniquely identify the new client device.

After a client device has been assigned to a specific customer, the scheduler sends the customer's initial media list (i.e., priority list) to the client device as shown at (3) at FIG. 5. Significantly, the selected media files, in order of priority as selected by the customer, are copied from the media server(s) to the client device's hard disk as depicted at (4) at FIG. 5 prior to shipment of the client device to the customer. The distributed media delivery system usually copies as many of the media files on the customer's priority list as can be installed on the client device before the device is shipped so that the user will already have these initial files when he or she receives the client device. For example, if the client device includes an 80 GB hard disk, 30 or more media files on the user's priority list may be copied to the hard disk before the set-top box is shipped to the user. In the event the user has not made any selections or the list is shorter than the available storage, the scheduler will determine a “best guess” list for that user and copy those files to the client device. This enables the user to start viewing the files immediately upon installation. This is also another way in which bandwidth into the user network is conserved by the system and methodology of the present invention.

Another alternative possibility is a case where the user purchases a new client device (STB) from a retail outlet (e.g., Best Buy). In some cases the set-top box will be connected to the retailer's LAN and the media files will be transferred from a caching server located at the store. Where that is not possible, the user will take the STB home and the file transfer of their selected files will take place later. It should be noted that in this case the client device already may be pre-loaded with media files selected by the scheduler during the manufacturing process. Those skilled in the art will appreciate that a number of other variations for the provisioning of media files are also possible.

When the user receives the client device (STB), he or she connects the device to a television or display device and an electrical socket. The STB is also connected to a home network of some sort. In the preferred implementation, “HomePlug” networking is recommended for incorporation of the client device into the home network. “HomePlug” is a networking technology that modulates the network signals on the home electrical wiring. HomePlug products suitable for use in connection with the present invention include NetGear XE102 Wall-Plugged Ethernet Bridge, NetGear Model XA601 Powerline USB Adapter, and NetGear Model XA602 Powerline Ethernet Adapter (available from NetGear of Santa Clara, Calif.). Other suitable HomePlug providers include Linksys Group, Inc., Belkin Corporation, Siemens, and ST&T Instrument Corporation. In the presently preferred embodiment, the HomePlug technology is built into the client device so that when the user plugs it into the wall socket to receive electricity, the client device is also connected to the local network. In this case, the user also has a broadband networking connection to the Internet, such as a routing device and a HomePlug bridge from the router. This enables the client device to connect out over the broadband connection to the scheduler and to other media file servers and client devices. Although HomePlug powerline routing is used for networking the client set-top box in the presently preferred embodiment, the client device may also be directly connected to a DSL modem, a Cable modem, or the like for connecting to the Internet. Alternatively, the client device may be connected using other networking technologies including, but not limited to, HPNA, wireless (e.g., IEEE 802.11), wireline (e.g., CAT-5 cable), and the like.

Activation of New Client Device

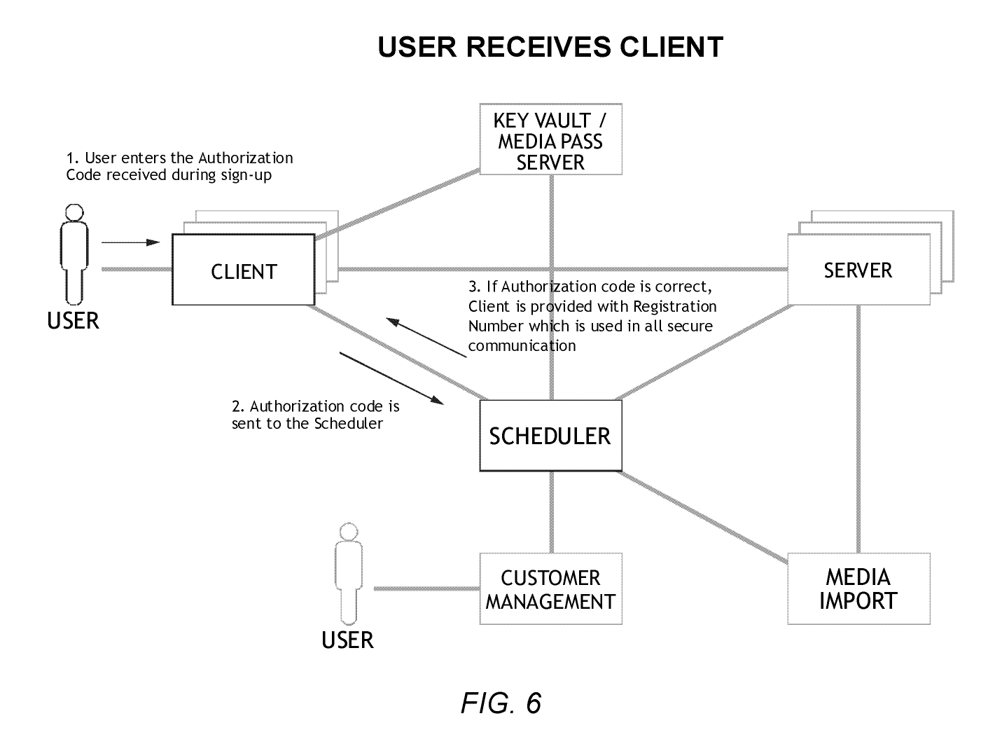

FIG. 6 is a block diagram depicting the activation of a new client device after the user receives and installs the client device. When a new client is installed and turned on for the first time, the user enters the authorization code received during sign-up as shown at (1) at FIG. 6. The authorization code is then sent to the scheduler as illustrated at (2) at FIG. 6. If the authorization code received by the scheduler is correct, the scheduler provides the client with a registration number which is used for secure communications as shown at (3) at FIG. 6. Among other things, this process ensures that the client device was received by the authorized user (i.e., the person that subscribed) before access to the network/community is provided. It should also be emphasized that communications between and among client and server components are encrypted (e.g., using SSL) and are on an authorized basis.

Importing New Items of Media Content

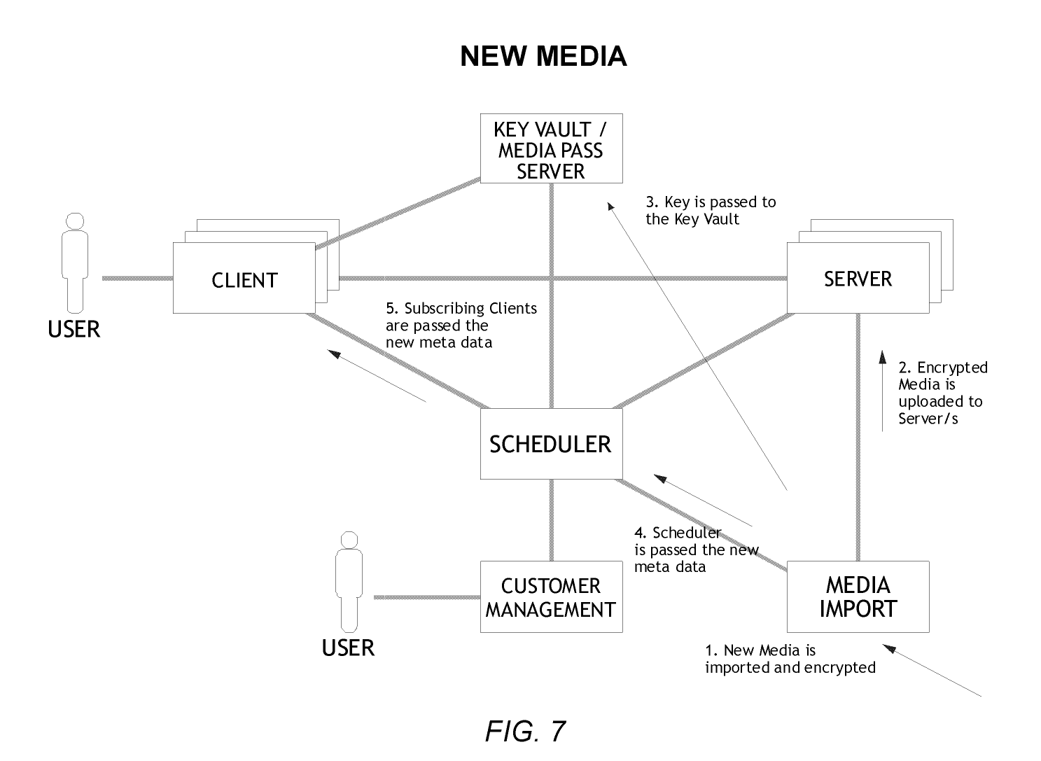

FIG. 7 is a block diagram illustrating the importation of new items of media content into the distributed media delivery system. As shown at (1) at FIG. 7, new media is imported into the system and encrypted by the media import module. The encryption system used in the currently preferred embodiment provides for frame-by-frame encryption of media content using SecureMedia's Indexed encryption method. After encryption, the encrypted media is sent to the media server(s) as depicted at (2) at FIG. 7. The key for decryption of the media file is also sent to the key vault as provided at (3) at FIG. 7. It should be noted that from this point until the media is decrypted for playback by a specific customer at a client device, all copies of the media stored and transferred by the distributed media delivery system are encrypted. Unencrypted copies of the media are generally not stored anywhere on the system. The process for providing keys to users for decryption and playback of media files is described below. The media import module also provides meta data (e.g., category, genre, title, copyright, content owner, language, and so forth) regarding newly imported media files to the scheduler as shown at (4) at FIG. 7. Users that have subscribed to the particular catalog(s) including the newly imported file are then passed the new meta data for local storage on the client device as illustrated at (5) at FIG. 7. This enables users to see on their set-top boxes that new titles are available for download and playback.

Adding Items to Priority List

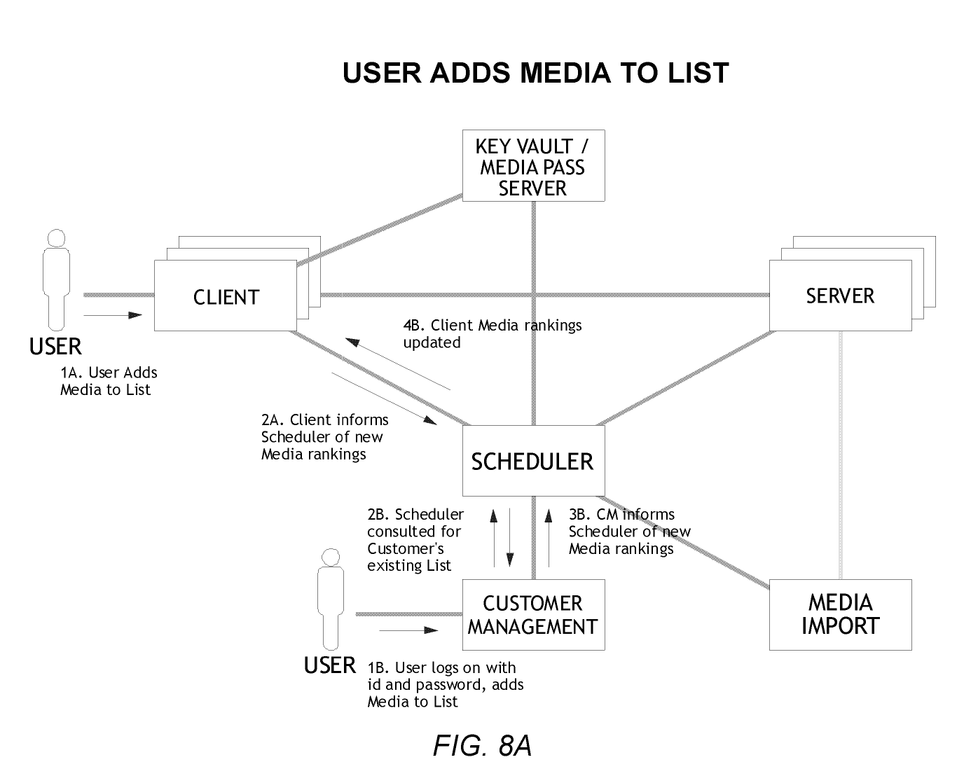

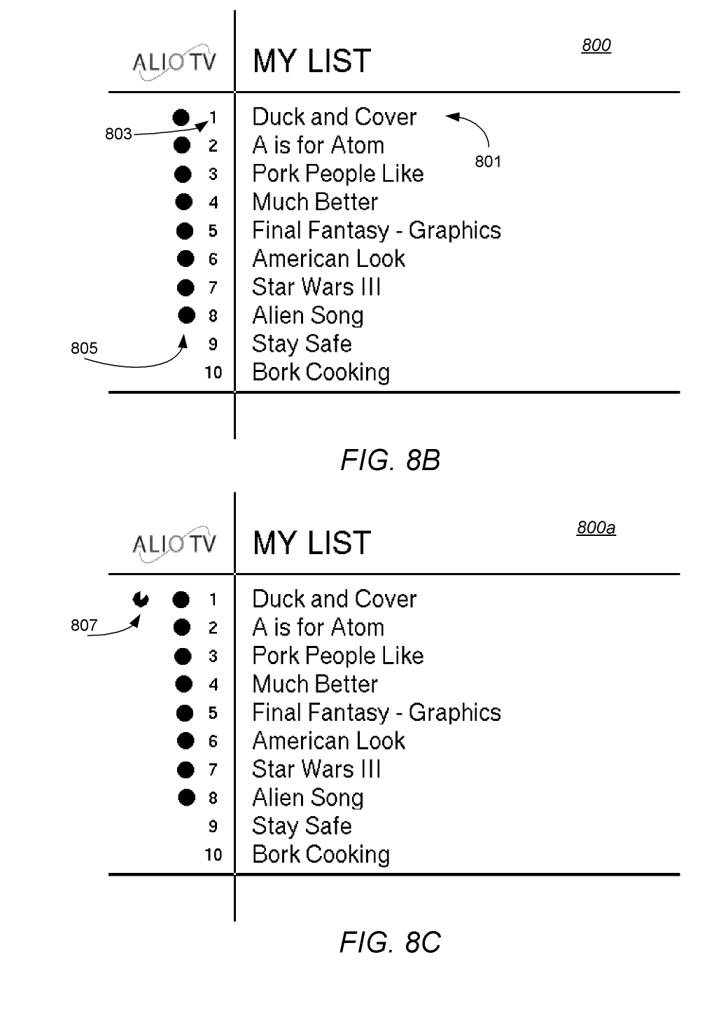

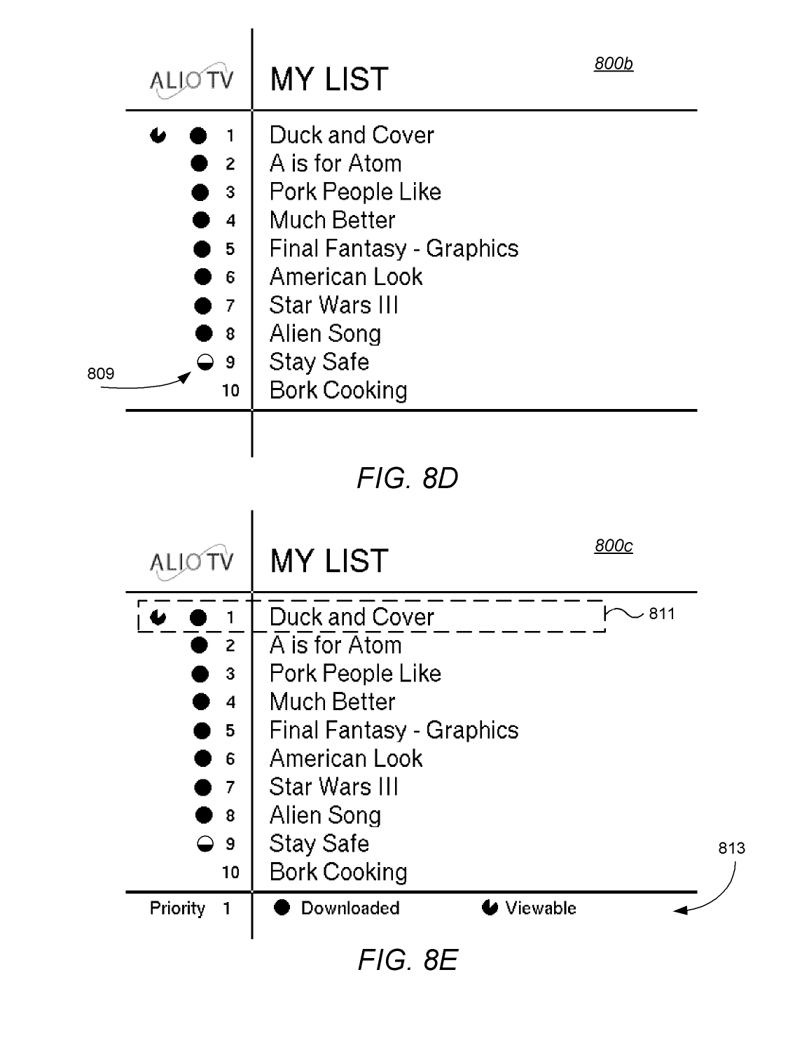

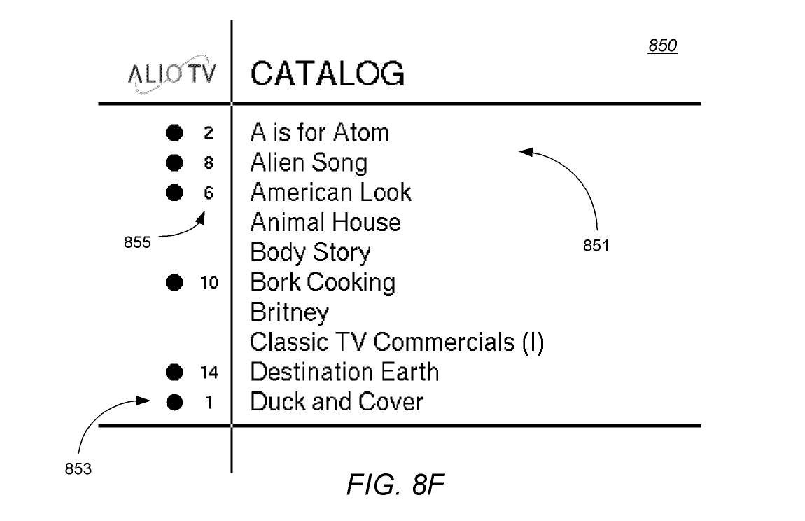

FIG. 8A is a block diagram illustrating a user adding media to his or her priority list. One can think of the priority list as a type of custom menu. A particular catalog may, for example, contain more than 15,000 titles. As it can be difficult to navigate a large catalog of this nature, the priority list serves as a custom list, in priority, of those titles that the user may be interested in viewing. A user may currently request additional media files for viewing by adding items to his or her priority list in one of two ways. A user may add items to his or her priority list either by using the client device or by using a Web browser connected via the Internet to the distributed media delivery system's customer management module. Both of these will now be described.

The client device typically stores a copy of the catalog(s) to which the user has subscribed or the client otherwise has access to these catalog(s) (e.g., via a network connection). The user may browse the catalog and select items to add to his or her priority list at the client device as provided at (1A) at FIG. 8A. In response, the client informs the scheduler of the new priority list as illustrated at (2A) at FIG. 8A. The scheduler then uses this information in determining which media files are to be delivered to the client.

Alternatively, a user may add items of media content to his or her priority list through the customer management module using a Web browser (e.g., from a computer at his or her home or office which is connected to the Internet). For example, a user may log on to the customer management Web server as provided at (1B) at FIG. 8A with his or her customer ID and password. After the user logs on, the customer management module consults the scheduler for the user's existing priority list as shown at (2B) at FIG. 8A. After the user adds items to his or her priority list, the customer management module informs the scheduler of the new priority list rankings as depicted at (3B). The scheduler then updates the media rankings in the user's priority list and informs the client of the updated rankings (i.e., priority list) as provided at (4B) at FIG. 8A.

FIG. 8B is a bitmap screenshot showing an example of a user's priority list. “My List” screen 800 represents an individual user's priority list. As shown in this example, the user has specified the movie “Duck and Cover” (shown at 801) as the user's #1 priority (indicated at 803). This is followed on the list by the user's priority ranking of other movies, such as “A is for Atom” as #2 priority, “Pork People Like” as #3 priority, and so forth and so on. A first set of status icons or glyphs 805 indicate whether a given movie is downloaded or not. A movie that is “downloaded” is one in which an encrypted copy of the movie then resides on the user's local system (e.g., resides on the user's STB hard disk). Thus, for the example shown, the user's priority items #1-#8 have been downloaded and now reside locally in encrypted form. These downloaded items may now be watched by the user at any time (of course, subject to billing/payment constraints).

Once a user wants to play a movie, he or she goes through the process of obtaining authorization to play the movie. Upon receiving the user's request to play the movie “Duck and Cover,” the system would check the user's account and then display a confirmation screen (not shown) for confirming the order. If the user decides to proceed with the order, he or she clicks a confirmation screen button whereupon the confirmation screen is dismissed and the movie begins playing. When the user has stopped watching the movie, the system returns to the “My List” screen, now 800a in FIG. 8C. As shown, the screen 800a includes an additional “viewable” screen icon at 807. The “viewable” icon is a pie-shaped icon indicating that a given movie is still viewable (i.e., for some subset of time remaining for the ordered movie, such as time remaining in a 24 hour viewing period). Over time, the “viewable” icon is gradually updated to indicate less and less time available for the movie to be viewed, until finally the movie is no longer available for viewing. Once the movie is no longer viewable, the user must obtain reauthorization should he or she wish to watch the movie again.

As shown in FIG. 8D, the “My List” screen (now 800b) also includes feedback to indicate the current download status of a given movie. For example, the system has now initiated downloading of the movie “Stay Safe.” To indicate the download progress, the screen 800b displays a “downloading” icon 809 in the form of a partially filled circle. As more and more of the movie is downloaded, the icon progressively fills. After downloading is complete, the icon 809 becomes a full circle. In this example, the movie “Bork Cooking” has no circle whatsoever, thus indicating that downloading has yet to commence for it. Finally, as shown in FIG. 8E, the “My List” screen (now 800c) also includes a selection cursor 811 for selecting different items, and a status line 813 for showing status information for a given selected item. Thus in the example shown, selection of the movie “Duck and Cover” has corresponding status information of “Priority 1”, “Downloaded”, and “Viewable”, as shown in the status line 813.

When the user wishes to add additional movies to his or her priority list, the user goes to another user interface screen, the catalog screen. FIG. 8F shows a simple example of a catalog screen 850. As shown, the catalog screen 850 includes an alphabetical listing 851 of all of the movies available on the system. Although not shown in the catalog screen 850, a more complex listing of movies may include filtering, such as via genre (e.g., drama, comedies, action, etc.). In a manner similar to that shown for the “My List” (priority) screen 800, the catalog screen 850 includes icons or glyphs 853 for indicating the download status of the various movies shown on the list. Additionally, the catalog screen 850 also includes priority information 855 for indicating what ranking (if any) each displayed movie has (relative to the user's own priority list). For example, the movie “A is for Atom” is indeed the #2 priority item in the user's priority list. Conversely, the movie “Animal House” does not get a priority ranking and is not downloaded, because of the user has not placed it on his or her priority list.

Rearranging Priority List

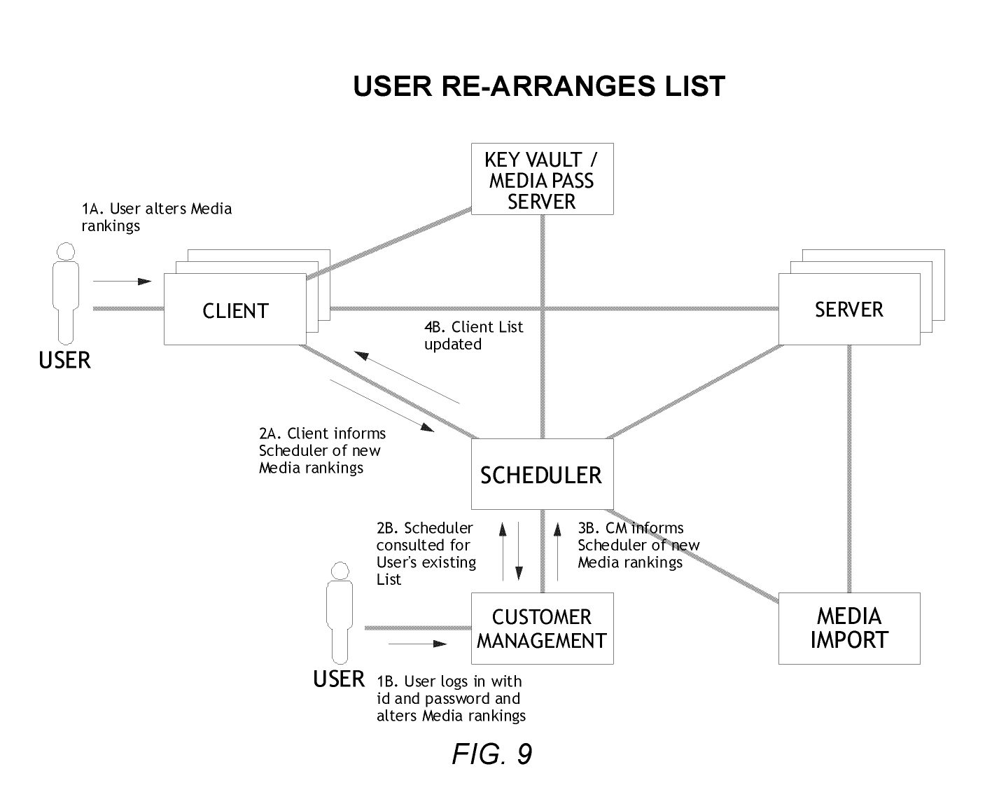

Similarly, the user can rearrange the priority list from either the client device or through the customer management Web server. FIG. 9 is a block diagram illustrating a user rearranging his or her priority list. As shown, a user may alter the media rankings provided in his or her priority list at the client device as provided at (1A) at FIG. 9. For example, the customer may wish to alter the priority list in order to obtain earlier access to particular items given that the scheduler uses the priorities assigned by the user to each item when deciding what files should be downloaded to the user's set-top box. In response, the client informs the scheduler of the new rankings as depicted at (2A). The user may also log in to the customer management Web server with his or her ID and password as provided at (1B) at FIG. 9. The scheduler is consulted for the user's priority list at (2B) and the altered media rankings entered by the customer are provided to the scheduler as illustrated at (3B) at FIG. 9. In response, the scheduler updates the priority list and transfers the updated priority list to the client as provided at (4B) at FIG. 9. Here, the act of adding new items to the priority list from the catalog may be considered an alternative to re-arranging the list. The user has the option of adding new items to the end of the list or he or she can insert them before existing items on the list. For example, a user can browse the catalog and decide to make a new item the user's highest priority item.

Transfer of Media to Client from Media Server or Peer

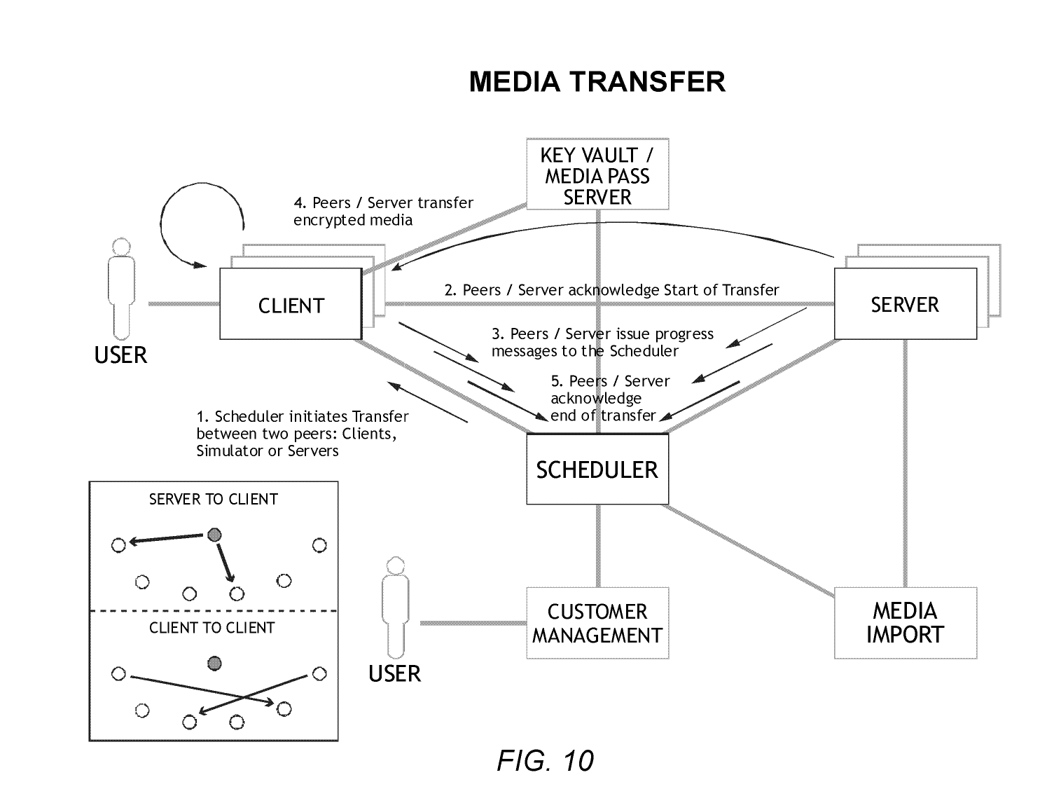

FIG. 10 is a high-level block diagram illustrating a transfer of media to a client from a media server or another client (peer). As previously described, the distributed media delivery system's scheduler knows the priority lists of all users and also knows what media files are installed on each of the media servers and the clients. The scheduler also has information about items that are currently in process of being transferred between (and among) clients and servers. On the basis of this information, the scheduler determines the media file(s) that should be delivered to a given client as well as when and from where each file should be transferred. Among the factors that the scheduler considers are the following: which client needs the file the most (e.g., which client is the one least-most recently served by a download), what client(s) and/or server(s) have a copy of the file that needs to be sent, and who should send the file (e.g., the device least-most recently originating and sending information). Other factors that may be considered include the network on which the clients (peers) and/or servers that are to send and receive the file are located as well as the geographic location of the recipient and the proposed sender as well as measured network latency and throughput. These factors, among others, may influence the selection of the most appropriate channel for delivery of media to a particular client.

Once the scheduler has decided how a particular media file is to be transferred, the scheduler also manages the transfer process. The scheduler initiates the transfer of the media file from a media server or client (peer) by informing both the sending and receiving parties of the transfer as shown at (1) at FIG. 10. It should be noted that although this discussion refers to a single server or peer transferring data to a client, a plurality of servers and/or peers may be employed for sending a file to the client. The scheduler may also instruct the parties about what portion of a particular file is to be sent at a given time. After receiving notice from the scheduler, the two systems both acknowledge that the transfer is about to start at (2) and then issue a progress message back to the scheduler as illustrated at (3) at FIG. 10 to inform the scheduler about the status of the transfer. This enables the scheduler to know dynamically how the transfer is progressing and also ensure that the distributed media delivery system is actually succeeding in transferring the data.

The server and/or peers transfer encrypted media to the client as provided at (4) at FIG. 10. When a transfer is completed, the peers and/or servers send an acknowledgment to the scheduler indicating that the transfer has been completed as depicted at (5) at FIG. 10. Once the entire file has been transferred, a secure method of determining that the file has been copied correctly is performed. The currently preferred embodiment calculates the SHA1 hash value of the entire file and submits it to the scheduler for verification. If the values match the scheduler acknowledges that the transfer was successful. Note that at any one time there are likely to be a considerable number of transfers in process amongst various clients and servers. Because of the large number of peers that can be involved in transfers from time to time, on an overall basis the distributed media delivery system can scale up to deliver a large volume of media content even though the bandwidth available to many of the clients may be rather limited (e.g., 256 Kps upload capability).

Purchasing a Movie for Viewing

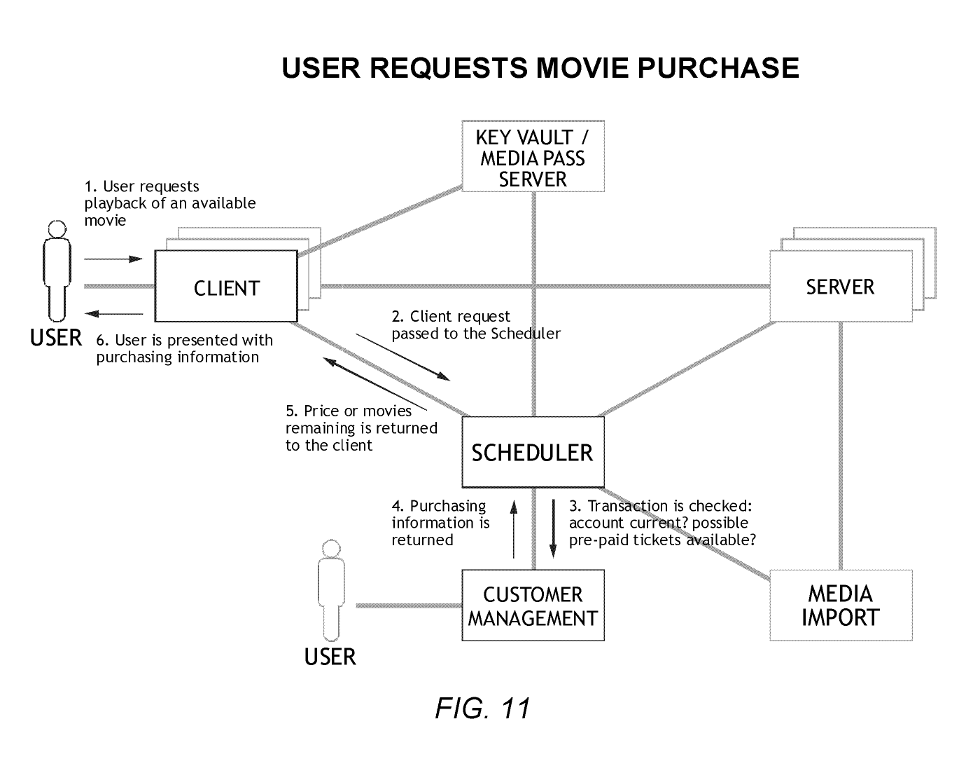

After a media file (e.g., a movie) has been downloaded to a client device, a user may wish to view the media. For instance, a user may browse his or her priority list at the client device and select a movie that is available (in encrypted form) on the set-top box. In response, the distributed media delivery system performs several actions. Before providing access to the movie, the system must determine the basis on which the user is obtaining the movie. FIG. 11 is a block diagram illustrating the processing of a user request to purchase (or rent) a movie for viewing. When the user requests playback of an available movie at (1), the client sends a message to the scheduler as shown at (2) at FIG. 11. The scheduler, in turn, sends a message to the customer management module as provided at (3) to request authorization. A number of decision factors are checked, including the following: a) account status; b) geographic location (e.g., is the client device in a geographic location that is authorized for the requested movie) supplied by Quova of Mountain View, Calif.; and c) has the user recently paid to watch the movie and is still within the agreed upon viewing window (for example, the user is allowed to watch a video for 24 hours and is still within that viewing window).

In response, purchasing information provided by the customer management module at (4) is returned to the client as provided at (5) for display to the user as illustrated at (6) at FIG. 11. For example, a message may be sent back to the client set-top box to display a message to the user indicating the price that will be billed or collected from their account when they press the OK button on the remote. The user can then decide whether or not to purchase (rent) the movie. If the user elects to purchase the movie, the operations described below are performed for providing the authorization (decryption) key necessary for the user to decrypt and play the movie.

Providing an Authorization Key to Client

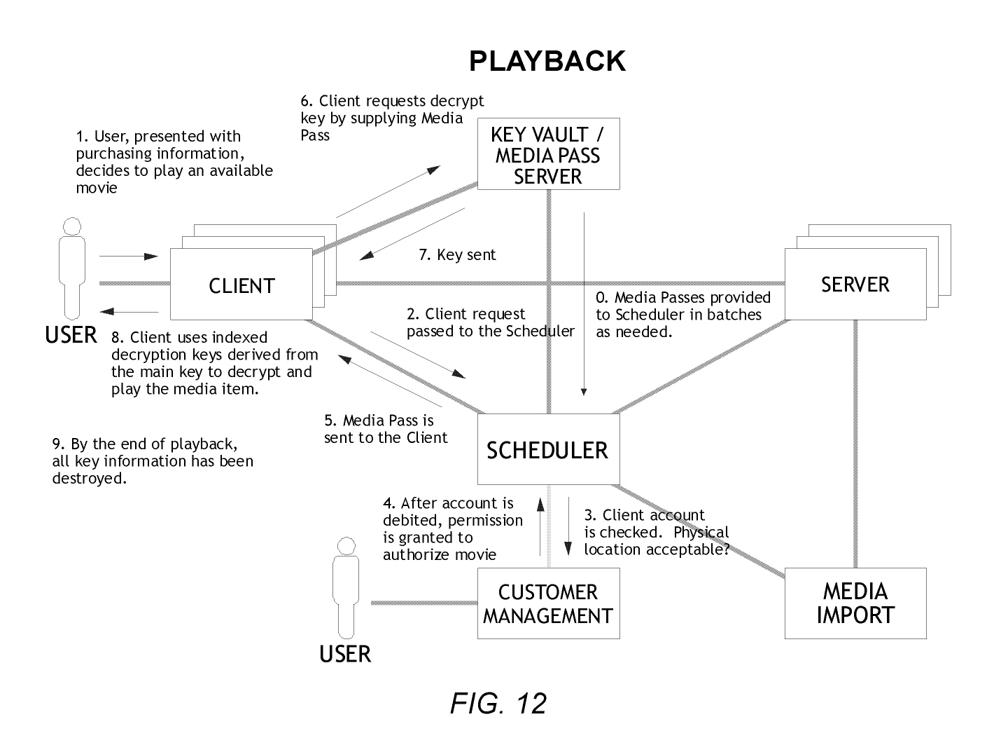

FIG. 12 is a block diagram illustrating the operations of the distributed media delivery system in providing an authorization (decryption) key to a client enabling the client to decrypt and play a movie. After a user is presented with purchasing information, the user may elect to purchase the movie for viewing as depicted at (1) at FIG. 12. For example, the user may press “OK” in response to the purchasing information displayed by the client device. In response, the client sends a message back to the scheduler at (2) which the scheduler passes on to the customer management module to check the user's account and record the transaction as illustrated at (3) at FIG. 12. Assuming the purchase is authorized, the customer management server responds to the scheduler at (4) by granting permission to the scheduler to authorize viewing of the movie. The customer management server may also indicate the type of authorization to be granted to the client. In the presently preferred implementation, a SecureMedia Encryptonite™ System is used for supplying the client with a “media pass” that allows a one time play of the video as provided at (5) at FIG. 12. With this core mechanism, the present invention supports the implementation of a number of business models such as the “24 hour rental”, where the user may watch a media item as many times as possible within a 24 hour period. In this case, after the initial payment and the viewing as described above, each time the user requests a new play, the scheduler is contacted, it in turn contacts the CMS and if the play request is during the 24 hour window, the delivery of another media pass is authorized. The media pass is used to collect the decryption key and the play begins. In all cases, the “media pass” or ticket can be considered as a right to obtain the authorization key. The approach of the currently preferred embodiment is to separate the business rules governing access to the media from the actual issuance of a physical key that enables the user to play the media.

After the client has received the media pass, the client issues a request to the key vault/media pass server for a decrypt key as provided at (6) at FIG. 12. In response, the key vault/media pass server sends the key to the client at (7) which the client uses to decrypt and play the media item as illustrated at (8) at FIG. 12. As previously described, the presently preferred embodiment of the present invention uses an Encryptonite security subsystem from SecureMedia for issuance of authorization (decrypt) keys. The client may use the key to decrypt, frame by frame, the media available on the hard disk of the client set-top box. When the playback of the media file is complete, the key is automatically destroyed as provided at (9) at FIG. 12. For security reasons, the key is not stored on the client but instead is essentially discarded after use. If the client wanted to watch the movie again, a request is sent to the scheduler from the STB, the business rules would be consulted at the CMS, and (assuming the repeat viewing was permitted by the rules) another media pass generated to enable the client to obtain the necessary decrypt key.

Decryption and Playback of Media at Client Device

As previously discussed, media files are delivered to a client device in encrypted and compressed form (e.g., via an MPEG or Windows Media 9 style encoding). The system and methodology of the present invention provides several techniques for securing the encrypted, compressed media files stored on a client device and protecting these media assets against unauthorized use. These security measures include a secure client boot process which provides for initialization of the client device in a secure manner as well as well as providing for on-chip decryption of media files for playback at the client device. These security techniques are described below in greater detail.

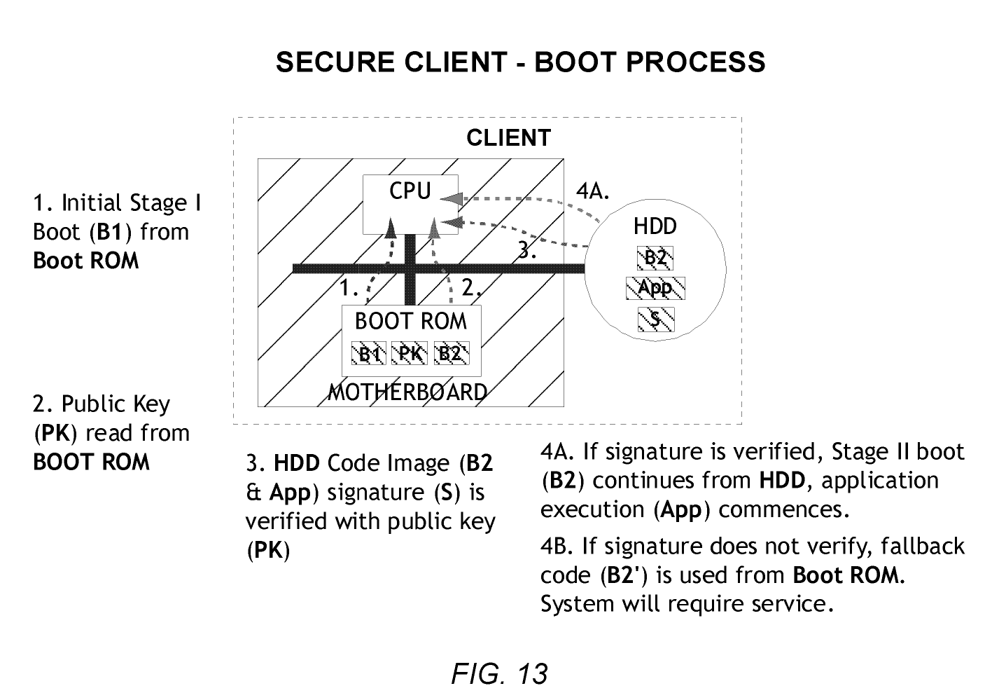

FIG. 13 is a block diagram illustrating the secure client boot process that is employed on a client set-top box (i.e., client set-top box 375 as illustrated at FIG. 3C). The secure client boot process is employed when the set-top box is powered up and provides for initialization of the client in a secure manner. This is important given that the hard disk drive is physically separate from the motherboard of the set-top box in order to provide increased security and make it more difficult for one to obtain access to decrypted, but still compressed media files. In order to thwart these types of attempts, the approach of the present invention provides for using a digital signature process for confirming the validity of the software on the hard disk.

When the client set-top box is powered up, the CPU performs an initial (first) stage boot (B1) from the boot ROM to begin to load the operating system. In this first stage boot (B1), enough information is obtained for the CPU to communicate with the hard disk drive and other components on the motherboard. In the second stage, the boot process continues by initially reading in (as data) the second stage boot (B2) from the hard disk drive. As shown at FIG. 13, the secure client boot process provides at (1) with an initial stage boot (B1) from the boot ROM. The public key (PK) is then read from the boot ROM at (2) and the hard disk drive code image (B2 and App) is checked by verifying its signature with the public key at (3) as provided at FIG. 13.

If the signature is correct, this verifies the validity of the second stage boot (B2) and the application software on the hard disk drive. In this event, the second stage boot (B2) continues from the hard disk. After the second stage boot (B2) is completed the application (App) commences execution as shown at (4A) at FIG. 3. In other words, if the signature is verified, the data that is on the hard disk can be executed by the CPU (rather than just read in as data). However, if the signature is not verified, this may indicate evidence of tampering with the programs (possibly in an unauthorized attempt to gain access to the media files in compressed, but unencrypted, format). In this case, the second stage boot from the hard disk drive does not continue, but instead fallback code (B2′) is executed from the boot ROM as illustrated at (4B) at FIG. 13. This typically will inform the user that the hard disk appears to have been compromised and will require service. This process disables the set-top box and makes it more difficult for a malicious user to obtain unauthorized access to encrypted media files stored on the set-top box.

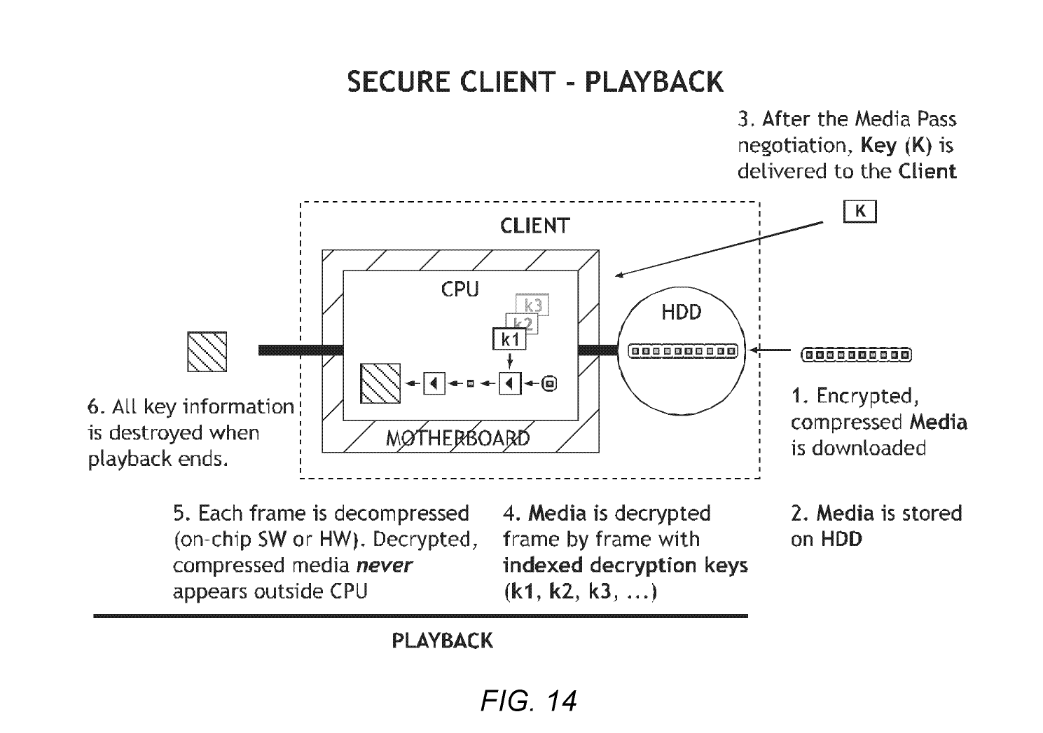

FIG. 14 is a block diagram illustrating the decryption and playback operations at a client device. Once the client has obtained an authorization key for decryption and playback of a particular media file, the key is used to decrypt the file as illustrated at FIG. 14. As shown, the media is decrypted frame by frame with indexed decryption keys generated on the client. Significantly, the methodology ensures that decrypted, compressed media is not removed from the client device's CPU and is secured so that it is very difficult for one to obtain copies of the media in unencrypted, compressed form. In addition, all key information is destroyed when playback ends, thereby providing further security protecting the media content against unauthorized use. These operations will now be described in more detail.

Initially, encrypted, compressed media is downloaded to the set-top box as shown at (1) and is stored on the hard disk drive as shown at (2) at FIG. 14. As described above, when a user wishes to play media stored on the set-top box, the client obtains a media pass which enables the client to obtain a decryption key (or authorization key) from the key vault/media pass server. As provided at (3) at FIG. 14, after media pass negotiation, the key (K) is delivered to the client set-top box.

During playback a media file is decrypted frame by frame using indexed decryption keys (k1, k2, k3, and so forth) as provided at (4) at FIG. 14. Each frame is decompressed using on-chip software and/or hardware as provided at (5) and all key information is destroyed as provided at (6) at FIG. 14 when playback ends. In the presently preferred embodiment, the secure client playback process is implemented in software that is run using the Equator BSP-15 processor. As discussed above, the Equator BSP-15 processor includes an on-chip DES engine enabling on-chip decryption of media files. This provides increased security for protecting the media files as it allows one-chip handling of protected content, without decrypted streams passing from one chip to another. This approach ensures that decrypted, compressed media does not appear outside the CPU.

Methodology for Scheduling Media Transfers

The scheduler operates in an iterative looping fashion, attending to its tasks one at a time, then restarting the loop. The internal operation is represented by the following pseudocode.

1: while( 1 )
2: {
3: // scan client list for high priority transfers to
4: // initiate
5: create_high_priority_transfers( );
6:
7: // scan client list for low priority transfers to
8: // initiate
9: create_low_priority_transfers( );
10:
11: // check for transfers that have timed out
12: // cancel those that have
13: monitor_transfers( );
14:
15: // check for outgoing messages that have been
16: // retried too many times and retire them
17: // and put the target client offline
18: monitor_messages( );
19:
20: // check for any clients that have not been heard from
21: // for a long time - put them offline
22: monitor_clients( );
23:
24: // scan for any new messages for the scheduler
25: get_new_messages( );
26: for all new messages
27: {
28: // act on the messages that have been received
29: process_messages( );
30: }
31: }

As shown, the method operates as follows. At the outset, a loop is established at line 1. Next, the method scans a given client list for high priority transfers to initiate, at line 5. This is followed by the method scanning the client list for low priority transfers to initiate, at line 9. Housekeeping is performed at line 13 to cancel any transfers that have timed out (pursuant to a system-configured timeout value). At line 18, the state of messages is monitored. Here, the method checks outgoing messages that have been retried too many times. In such a case, the unsuccessful messages are retired and the respective client's state updated to “off line.” Similarly, the state of clients is monitored at line 22, such that any client that is nonresponsive is also marked as “off line.” Finally, the method gets any new messages posted to the scheduler at line 25, and proceeds to process all such messages at line 29.

The functions that initiate the transfers, create_high_priority_transfers( ) and create_low_priority_transfers( ), may be represented by the following (generic) pseudocode.

1: create_x_priority_transfers( )
2: {
3: // get a list of clients at the appropriate priority level
4: get_x_priority_clients( );
5:
6: // iterate through all of them
7: for all clients c needing media
8: {
9: // find the top-ranked media item (m) that is not completely
10: downloaded
11: m = chose_media_item( c );
12:
13: // find a client or server (d) that can provide the media
item
14: d = find_donor( m );
15:
16: // create a new transfer record that summarizes the
transfer
17: t = new Transfer( c, d, m );
18:
19: // store it
20: store( t );
21:
22: // create messages to the receiving client c and the
donor to
23: perform the xfer
24: m1 = new Message( c, transferStart, d, m, send );
25: m2 = new Message( d, transferStart, c, m, receive);
26:
27: // send the messages
28: send( m1 );
29: send( m2 );
30: }
31: }

Although the basic approach is the same, the high and low functions differ in their selection of clients to send media to. In particular, each function gets a list of clients at the appropriate priority level (i.e., high or low, for the respective transfer function), as shown at line 4. Next, a loop is established at line 7, for looping through all clients needing media. The function or method chooses the top-ranked media item that is not completely downloaded, at line 11, and finds a client or server (“donor”) that can provide that particular media item at line 14. A transfer record describing the transfer event is created at line 17 and is stored at line 20. Now, the method constructs messages to instruct the donor and receiving client to perform the transfer, as indicated at lines 24-25. Finally, the method sends the messages to the respective donor and receiving client, at lines 28-29, whereupon the actual transfer takes place.

The process whereby the system determines the clients that need the media may be embodied as follows.

1: Array< ClientInfo* >* ClientInfo::FindTopPriorityDownload
(
2: Array< ClientInfo *>* results,
3: AlioSession* alioSession )
4: {
5: char q[ CLIENT_INFO_QUERY_MAXSIZE ];
6: snprintf( q, CLIENT_INFO_QUERY_MAXSIZE,
7: “SELECT * from ” CLIENT_INFO_TABLE_NAME
8: “ WHERE media_unwatched_count = 0 AND”
9: “ media_list_size > 0 AND ”
10: “ downlink_current = 0 AND ”
11: “ connected = 1 AND ”
12: “ server = 0 AND ”
13: “ storage_capacity - storage_current >
%lld ”
14: “ ORDER BY media_out_time”
15: “ LIMIT %d ;”,
16: CLIENT_INFO_FREESPACE,
17: CLIENT_INFO_HIGH_MAX );
18:
19: return FindByQuery( results, alioSession, q );
20: }

Note that the process encapsulates SQL statements to ensure that the best clients are selected. In the foregoing, the particular difference between the high and the low priority is that high priority status is granted to those clients which have no media at all to watch (via the “media_unwatched_count=0” condition).

Methodology for Transferring Media Items

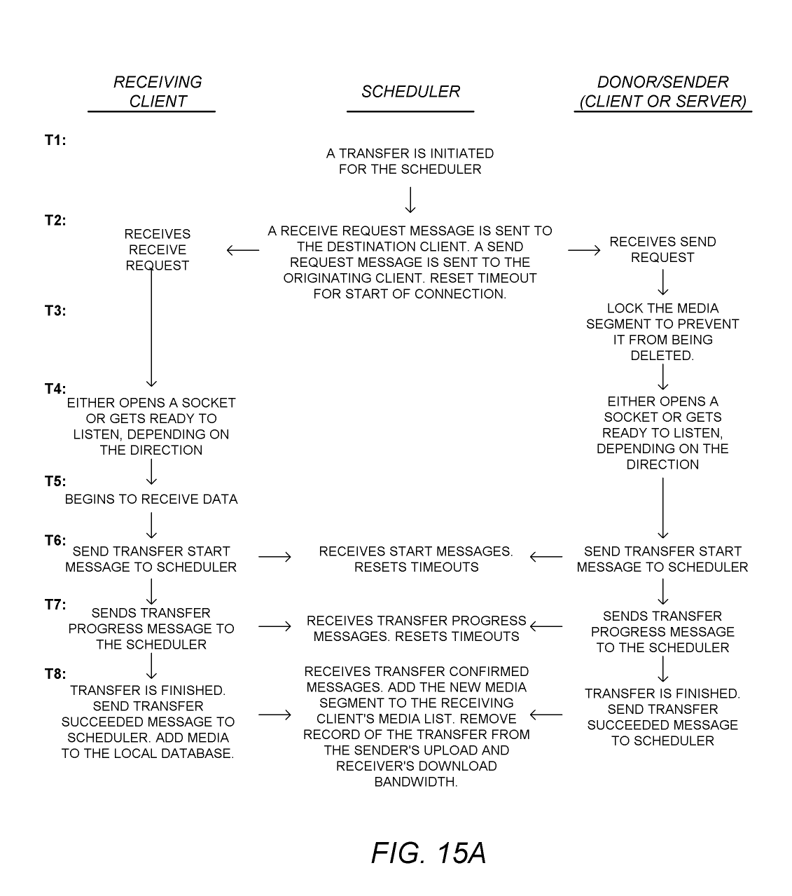

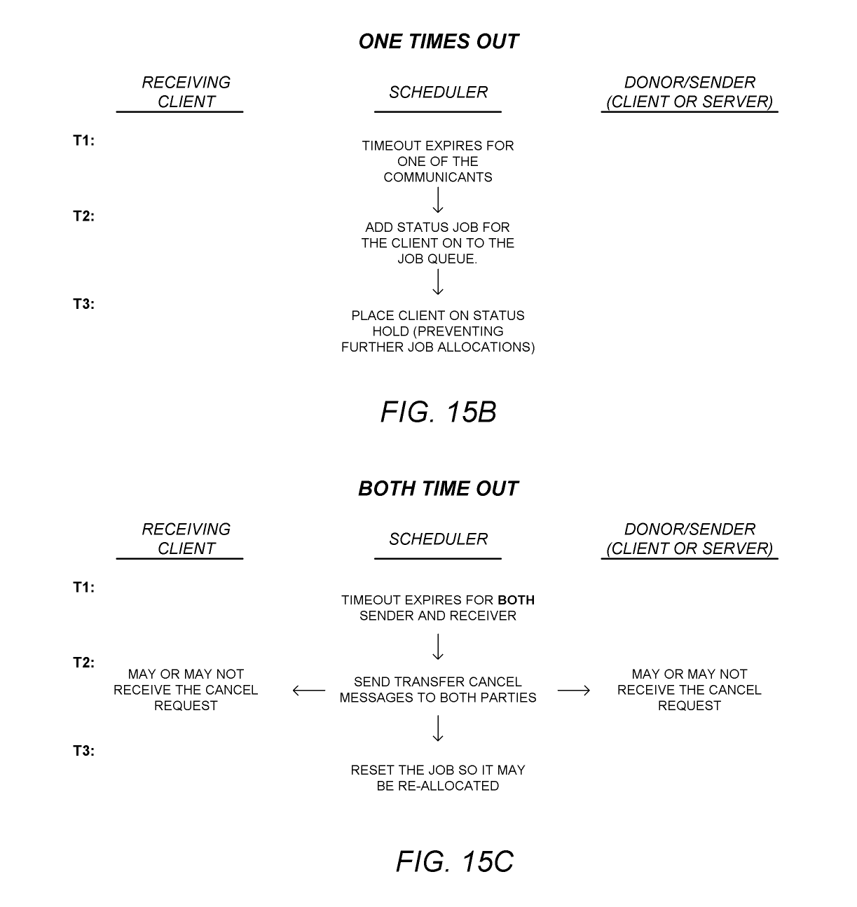

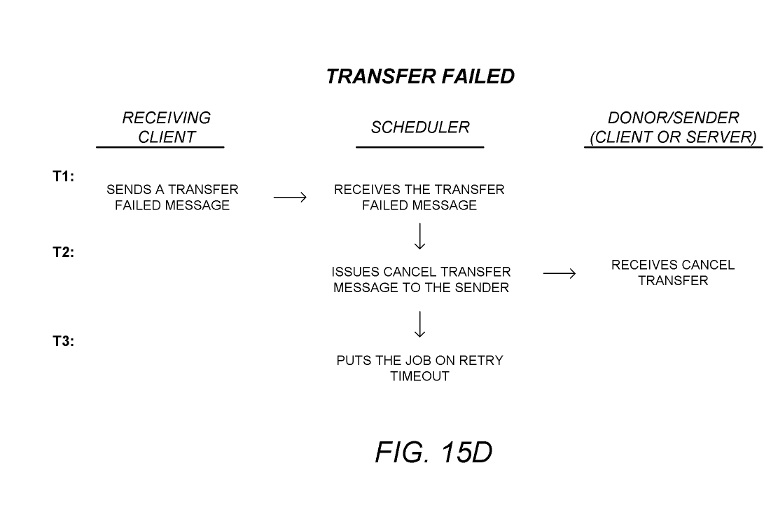

To transfer media items, the donor and receiving client (i.e., two clients, or client and server) are informed of the need for them to communicate. One is set up as a listener, the other as an initiator. Then they are allocated roles of sender or receiver. From there, they must transfer in data in the appropriate direction, issuing progress reports until the transfer is complete, whereupon they sign off. FIGS. 15A-D comprise a series of state diagrams illustrating interaction between the scheduler, a receiving (or destination) client, and an originating donor/sender client or server in transferring media files.

FIG. 15A is a state diagram detailing interaction between the scheduler, the destination or receiving client (“receiving client”), and the originating donor/sender client or server (the “sender”) in a transfer of a media file from the sender to the receiving client. As shown, at time T1, a transfer is initiated for the scheduler. At time T2, the scheduler sends a receive request message to the receiving client. Similarly, the scheduler sends a send request message to the originating sender (i.e., the donor/sender client or server) at time T2. Also, at time T2 the scheduler resets the timeout for the start of the connection.

Next, the sender locks the media segment to prevent it from being deleted at time T3. At time T4 the receiving client either opens a socket or gets ready to listen, depending on the direction of communication. Similarly, the sender either opens a socket or gets ready to listen at time T4. The receiving client begins to receive data at time T5. After the transfer of data commences, both the receiving client and the sender send transfer start messages to the scheduler at time T6. The scheduler receives the start messages from the receiving client and the sender at time T6 and resets the timeouts. At time T7 the receiving client sends a transfer progress message to the scheduler. The sender also sends a transfer progress message to the scheduler at time T7. The scheduler receives the transfer progress messages from both the receiving client and the sender and resets the timeouts at time T7 as illustrated at FIG. 15A.

When the transfer of data to the receiving client is finished at time T8, the receiving client sends a transfer succeeded message to the scheduler. The receiving client also adds the media to the local database. At this time T8 the transfer of data by the sender is complete, and the sender sends a transfer succeeded message to the scheduler. The scheduler receives transfer confirmed messages from the receiving client and the sender as shown at time T8 at FIG. 15A. The scheduler adds the new media segment to the receiving client's media list. The scheduler also removes the record of the transfer from the sender's upload and the receiving client's download bandwidth.

FIG. 15B is a state diagram illustrating a time out by one of the communicating parties (e.g., timeout status by either the receiving client or the sender). As shown at time T1 at FIG. 15B, a timeout expires at the scheduler for one of the communicants (i.e., the receiving client or the sender). At time T2 the scheduler adds the job status for the client to the job queue. The scheduler then places the client on status hold at time T3, thereby preventing further job allocations.

FIG. 15C is a state diagram depicting a time out by both of the communicating parties (i.e., both the receiving client and sender on timeout status). At time T1 the timeout expires at the scheduler for both the receiving client and the sender. The scheduler then sends transfer cancel messages to both the receiving client and the sender at time T2. The receiving client and the sender may (or may not) receive the cancel request message sent by the scheduler at time T2. Next, at time T3 the scheduler resets the job so that it may be re-allocated.

FIG. 15D is a state diagram detailing an example of a failed transfer. At time T1 the receiving client sends a transfer failed message to the scheduler. Also at time T1 the scheduler receives the transfer failed message sent by the receiving client. In response, the scheduler issues a cancel transfer message to the sender at time T2. The sender also receives the cancel transfer message sent by the scheduler at time T2. The scheduler then puts the job on retry and timeout status as shown at time T3 at FIG. 15D.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

1. A method for distributing media content to clients having peer-to-peer connectivity, the method comprising:
hosting an online catalog having a selection of media items available from a central repository, wherein at least some of the media items have already been previously transferred from the central repository to some of the clients;
responsive to the online catalog, receiving from each client a prioritized list of media items desired to be received for use;
based on the prioritized lists received from the clients and based on where various media items reside, determining a schedule for transferring media items; and
transferring the media items pursuant to the schedule, including transferring at least some of the items between clients using peer-to-peer connectivity.

2. The method of claim 1, further comprising:
upon completion of transfer of a particular media item at a given client, indicating at the client that the particular media item may be purchased for use.

3. The method of claim 1, wherein the selection of media items includes audio/video media items.

4. The method of claim 1, wherein the selection of media items includes various file types.

5. The method of claim 1, wherein the hosting step includes pre-loading media items on client devices supplied to users.

6. The method of claim 5, wherein said step of pre-loading media items includes pre-loading particular media items based upon user requests for particular media items.

7. The method of claim 5, wherein said step of pre-loading media items includes pre-loading particular media items based upon predicting media items likely to be needed.

8. The method of claim 1, wherein the transferring step includes transferring the media items to client playback devices.

9. The method of claim 1, wherein the determining step includes determining a schedule that minimizes bandwidth requirements.

10. The method of claim 1, wherein the determining step includes determining a schedule that minimizes transfers from the central repository.

11. The method of claim 1, wherein the determining step includes determining a schedule that maximizes transfers between clients that can occur within a reasonable period of time.

12. The method of claim 1, wherein the determining step is also based on storage available at each client for receiving media items.

13. The method of claim 1, wherein the transferring step includes transferring the media items using broadband connectivity.

14. The method of claim 1, wherein each media item is transferred in encrypted format.

15. The method of claim 14, further comprising:
receiving purchase instructions from a given client; and
in response to receiving the purchase instructions, decrypting the particular media item for playback at the given client.

16. The method of claim 15, further comprising:
checking the given client's account status before decrypting the particular media item for playback at the given client.

17. The method of claim 1, wherein the determining step includes:
determining which media items may be transferred from one client to another.

18. The method of claim 17, wherein the determining step further comprises:
determining which media items need to be transferred from the central repository to clients.

19. The method of claim 1, wherein the hosting step includes providing caching space at a client for storing media items not on the prioritized list of media items requested by said client.

20. The method of claim 19, wherein said determining step includes determining which media items need to be transferred from the central repository to said caching space at the client.

21. The method of claim 1, wherein the transferring step includes transferring the media items using wireless connectivity.

22. The method of claim 1, wherein the transferring step includes checking the media items transferred for determining that they have not been corrupted during the transfer.

23. A computer-readable medium having processor-executable instructions for performing the method of claim 1.

24. A downloadable set of processor-executable instructions for performing the method of claim 1.

25. A system for distributing media content to clients having peer-to-peer connectivity, the system comprising:
an online catalog having a selection of media items available from a central repository, wherein at least some of the media items have already been previously transferred from the central repository to some of the clients;
a server for receiving from each client a prioritized list of media items desired to be received for playback, and for determining a schedule for transferring media items based on the prioritized lists received from the clients and based on where particular media items reside;
a network, in communication with the server, for transferring the media items pursuant to the schedule, including transferring at least some of the items between clients using peer-to-peer connectivity; and
client devices, in communication with the network, for storing and playing back transferred media items.

26. The system of claim 25, wherein the selection of media items includes audio/video media items.

27. The system of claim 25, wherein the selection of media items includes various file types.

28. The system of claim 25, wherein transferred media items are transferred to the client playback devices for storage.

29. The system of claim 25, wherein the schedule is determined in an effort to minimize bandwidth requirements.

30. The system of claim 25, wherein the schedule is determined in an effort to minimize transfers from the central repository.

31. The system of claim 25, wherein the schedule is determined in an effort to maximize transfers between clients that can occur within a reasonable period of time.

32. The system of claim 25, wherein the schedule takes into account storage available at each client for receiving media items.

33. The system of claim 25, wherein the media items are transferred using broadband connectivity.

34. The system of claim 25, wherein each media item is transferred in encrypted format.

35. The system of claim 25, further comprising:
a module for receiving purchase instructions from a given client device; and
a module, responsive to the received payment instructions, for authorizing playback of the particular media item at the given client device.

36. The system of claim 35, further comprising:
a module for checking the given client's account status before authorizing playback of the particular media item at the given client device.

37. The system of claim 25, wherein the server determines which media items may be transferred from one client to another.

38. The system of claim 37, wherein the server determines which media items need to be transferred from the central repository to clients.

39. The system of claim 25, wherein the network includes wireless connectivity.

40. The system of claim 25, wherein the online catalog is accessible via an Internet browser program.

41. The system of claim 25, wherein the online catalog is accessible from the client devices.

42. The system of claim 40, wherein the online catalog is accessible from the client devices via a selected one of online connectivity and a local database at the client devices.

43. The system of claim 25, wherein the client devices comprise set-top boxes.

44. The system of claim 43, wherein the set-top boxes include hard disk storage and broadband connectivity.

45. The system of claim 25, wherein the central repository comprises a media server.

46. The system of claim 45, wherein the media server stores downloadable video media.

47. The system of claim 25, wherein the server includes a customer management module for tracking account status of each client.

48. The system of claim 25, wherein the server includes a key vault storing decryption keys that may be transferred to clients for playing back transferred media items.

49. The system of claim 48, wherein the server checks account status of a client before issuing a decryption key to the client.

50. The system of claim 48, wherein the server checks geographic location of a client before issuing a decryption key to the client.

51. The system of claim 48, wherein each decryption key automatically expires after some period of time.

52. The system of claim 48, further comprising:
television devices, in communication with the client devices, for playing back transferred media items.

53. The system of claim 25, wherein at least some of the client devices communicate with said network through a network connection.

54. A method for delivery of media content available on a plurality of devices having connectivity to one another, the method comprising:
determining media items available on each of said plurality of devices having connectivity to one another;
receiving priority lists from at least some of said plurality of devices, wherein each priority list represents a prioritized list of media items requested at a particular device;
selecting a particular media item to be delivered to a first device based on the priority lists and the media items determined to be available on the first device;
identifying at least one second device having the particular media item to be delivered to the first device; and
transferring the particular media item to the first device from at least one second device at which the particular media item is available.

55. The method of claim 54, wherein said plurality of devices includes a plurality of client devices having peer-to-peer connectivity to one another.

56. The method of claim 54, said plurality of devices includes at least one server having copies of media items for supply to client devices.

57. The method of claim 54, wherein said step of selecting a particular media item to be delivered to a first device includes selecting the first device to receive the particular media item from said plurality of devices.

58. The method of claim 57, wherein said step of selecting the first device includes determining a device least-most recently served by delivery of a media item.

59. The method of claim 57, wherein said step of selecting the first device includes comparing a priority list of a given device with the media items determined to be available on the given device, so as to evaluate need for delivery of a media item to the given device.

60. The method of claim 54, further comprising:
tracking measured performance of communications amongst said plurality of devices.

61. The method of claim 60, wherein said step of identifying at least one second device includes identifying at least one second device based, at least in part, on measured performance of communications between the first device and said at least one second device.

62. The method of claim 54, wherein said step of identifying at least one second device includes identifying said at least one second device based upon minimizing overall system bandwidth requirements.

63. The method of claim 54, wherein said step of identifying at least one second device includes making transfers from client devices having a copy of the particular media item when feasible, so as to conserve server resources.

64. The method of claim 54, wherein said step of identifying at least one second device includes identifying said at least one second device based upon minimizing time required to transfer the particular media item to the first device.

65. The method of claim 54, wherein said step of identifying at least one second device includes evaluating network location of the first device and said at least one second device.

66. The method of claim 54, wherein said step of identifying at least one second device includes determining a device least-most recently transferring a media item.

67. The method of claim 54, wherein said step of identifying at least one second device includes identifying a plurality of second devices, so as to share transfer of the particular media item amongst said plurality of second devices.

68. The method of claim 54, wherein said step of transferring the particular media item to the first device includes transferring portions of the particular media item from a plurality of second devices.

69. The method of claim 67, wherein transferring portions of the particular media item from a plurality of second devices includes selecting a certain portion of a media item to be delivered by a particular second device.

70. The method of claim 54, wherein said step of transferring the particular media item to the first device includes scheduling when the transfer should be initiated.

71. The method of claim 54, wherein said step of transferring the particular media item to the first device includes determining which device should initiate communications for delivery of the particular media item to the first device.

72. The method of claim 54, wherein said step of transferring the particular media item to the first device includes monitoring the transfer, so as to verify successful transfer of the particular media file to the first device.

73. The method of claim 54, wherein the transferring step includes verifying the transfer, so as to confirm transfer of a correct copy of the particular media file to the first device.

74. The method of claim 54, further comprising:
pre-loading media items on at least some of the plurality of devices.

75. The method of claim 74, wherein said pre-loading step includes pre-loading particular media items on a device based on user input at time of purchase of the device.

76. The method of claim 74, wherein said pre-loading step includes pre-loading media items based, at least in part, on predicted demand for particular media items.
